(19) United States
(12) Patent Application Publication
(10) Pub. No.: US 2023/0183589 A1
(43) Pub. Date: Jun. 15, 2023

(54) NITROGEN PURIFICATION FROM HYDROCARBON CONTAINING GAS USING ZEOLITE ITQ-55

(71) Applicant: ExxonMobil Technology and Engineering Company, Annandale, NJ (US)

(72) Inventors: Yu Wang, Lebanon, NJ (US); Edward W. Corcoran, JR., Nazareth, PA (US); Avelino Corma Canos, Valencia (ES)

(21) Appl. No.: 17/814,953

(22) Filed: Jul. 26, 2022

Related U.S. Application Data
(60) Provisional application No. 63/265,232, filed on Dec. 10, 2021.

(51) Int. Cl. C10L 3/10

(52) U.S. Cl. CPC C10L 3/105; C10L 3/104; C10L 2290/542

(57) ABSTRACT

This disclosure relates to the adsorption and separation of nitrogen in a feed stream (e.g., natural gas) using zeolite ITQ-55 as the adsorbent. A process is disclosed for removing impurities such as nitrogen while producing a high pressure hydrocarbon product. The process involves passing the feed stream through a bed of an adsorbent comprising zeolite ITQ-55 to adsorb nitrogen from the feed stream, thereby producing a product stream depleted in nitrogen at pressure as feed condition without need of recompression. The zeolite ITQ-55 has a mean crystal particle size within the range of from about 0.01 microns to about 40 microns. The feed stream is exposed to the zeolite ITQ-55 at effective conditions for performing a kinetic separation, in which the kinetic separation exhibits greater kinetic selectivity for nitrogen than for methane. The system and method of this disclosure are particularly suitable for use with feed streams utilizing rapid cycle PSA operations.

### CROSS REFERENCE TO RELATED APPLICATIONS

This application claims priority to and the benefit of U.S. Ser. No. 63/265,232 filed on Dec. 10, 2021, the entire contents of which are incorporated herein by reference.

This invention also relates to U.S. Ser. No. 63/265,230 filed Dec. 10, 2021 and U.S. Ser. No. 63/265,234 filed Dec. 10, 2021.

### FIELD OF THE INVENTION

This disclosure relates to the adsorption and separation of fluid components in a hydrocarbon containing feed stream (e.g., natural gas) using zeolite ITQ-55 as the adsorbent. Impurities such as nitrogen can be removed while producing a high pressure hydrocarbon product stream from natural gas feed streams.

### BACKGROUND

To satisfy the rising global demand for energy while simultaneously combatting the global greenhouse gas (GHG) emissions, low emission sources of energy will be required. One such source of energy that fulfills the requirements of high quality, economical viability and environmental sustainability is natural gas. However, the purification of natural gas is vitally important to meet US pipeline and minimum heating value specifications. A key separation required for this is the removal of nitrogen from methane, which is challenged because of the similarities in molecular size of nitrogen and methane (i.e., the two gases differ in kinetic diameter by only 0.16 Å).

Currently, the only commercial technology is cryogenic distillation for separating nitrogen and methane; however, cryogenic plants are complex and have high capital and operating costs. It is generally operated at temperatures below −100° C. (173 K) and pressures of ˜14.8 atm (˜200 psig). This process separates the gases based on the differences in their normal boiling points, which are −195° C. for N₂ and −162° C. for CH₄. These plants must process a relatively high volume of gas before they are economical, typically in the range of 100-500 million standard cubic feet per day (MMSCFD). Smaller gas fields cannot be economically treated, and the resources are left stranded. As a result, the gas producers often choose to “shut-in” high-N₂ reserves or rely on blending with low N₂ gas due to the high cost of distillation.

Membranes provide another option, but the methane permeate unfortunately experiences a significant pressure decrease, then requiring the gas to be recompressed to allow for pipeline transport. A potential technology is pressure swing adsorption (PSA), since a high feed pressure is already available, and the methane would, in theory, maintains its original feed (i.e. high) pressure.

Separation by PSA can be accomplished via either equilibrium or kinetic modes, but advanced sorbent materials are necessary to improve separation efficiencies, especially with the required high capacities. Equilibrium selectivities unfortunately favor methane sorption over nitrogen for all known sorbents (e.g. activated carbons, large-pore zeolites and molecular sieves, silica gels, and activated aluminas). Therefore, equilibrium-based separations are practical for the selective removal of methane from nitrogen, but won't be effective at removing a small percentage of nitrogen from bulk methane.

Kinetic separations would be preferred for this application owing to the small difference in kinetic diameters of these two molecules, and the need to adsorb nitrogen over methane. Zeolite 4A and carbon molecular sieves (CMS) have been examined for the separation, but are unable to provide the needed performance. The most advanced adsorbents explored are Engelhard titanosilicates (e.g., ETS-4), developed, and later purchased by BASF operating via a molecular gate adsorption technology (MGAT). The ETS-4 dehydration temperature was found to be a critical step for improving the kinetic adsorption and equilibrium selectivity of nitrogen over methane for this material. The optimum temperature for dehydration was 270° C., which removed enough water from the crystalline structure to cause a decrease in pore diameter for efficient separation of nitrogen from methane. So unfortunately, the feed gas must be dried to very low humidity levels to prevent deactivation in order to utilize this material.

Therefore, there is a need for the development of improved porous solid sorbents to effectively conduct the separation of nitrogen from methane, in particular, to enable high capacity removal of nitrogen from methane.

### SUMMARY

This disclosure relates to the use of zeolite ITQ-55 to remove nitrogen by kinetic separation for natural gas processing. The zeolite ITQ-55 exhibits high kinetic selectivity discriminating between nitrogen and methane. Furthermore, the kinetics can be tuned by the crystal size and temperature to enable the rapid cycle adsorption. As a result, the throughput can be enhanced for a large-scale natural gas processing, recovery of methane from coal mines, enhanced oil recovery, and the like. As an example for upstream natural gas processing, the rapid cycle processes can achieve high purity (>98% CH₄) and high recovery (>90%) of methane over a wide range of nitrogen concentration (e.g., nitrogen content from 4 to 20%). Additionally, the ITQ-55 can be applied to simultaneously remove CO₂ and other small size contaminants than CH₄ in natural gas processing.

This disclosure also relates to a process for removing impurities such as nitrogen from a hydrocarbon feed stream (e.g., natural gas) while producing a high pressure hydrocarbon product. The process involves passing a feed stream at feed pressure through a bed of an adsorbent comprising zeolite ITQ-55 to adsorb nitrogen from the feed stream, thereby producing a product stream, depleted in nitrogen, at feed pressure without need of recompression.

This disclosure relates in part to a process of adsorbing nitrogen from a feed stream containing hydrocarbons and impurities, wherein the hydrocarbons comprise at least methane and the impurities comprise at least nitrogen. The process comprises passing the feed stream at feed pressure through a bed of an adsorbent comprising zeolite ITQ-55 to adsorb nitrogen from the feed stream, thereby producing a high pressure product stream depleted in nitrogen. The zeolite ITQ-55 has a mean crystal particle size within the range of from about 0.01 microns to about 40 microns. The feed stream is exposed to the zeolite ITQ-55 at effective conditions for performing a kinetic separation, in which the kinetic separation exhibits greater kinetic selectivity for nitrogen than for methane.

This disclosure also relates in part to a process of adsorbing nitrogen and carbon dioxide from a feed stream containing hydrocarbons and impurities, wherein the hydrocarbons comprise at least methane and the impurities comprise at least nitrogen and carbon dioxide. The process comprises passing the feed stream through one or more beds of adsorbent comprising zeolite ITQ-55. The zeolite ITQ-55 has a mean crystal particle size within the range of from about 0.1 microns to about 40 microns. The feed stream is exposed to the adsorbent at effective conditions for performing a kinetic separation, in which the kinetic separation exhibits greater kinetic selectivity for nitrogen and carbon dioxide than for methane.

This disclosure further relates in part to a method for separating fluids. The method comprises exposing an input fluid stream comprising a first fluid component and a second fluid component to an adsorbent comprising zeolite ITQ-55 to form a rejection product fluid stream. The molar ratio of the first fluid component to the second fluid component in the rejection product fluid stream is less than a molar ratio of the first fluid component to the second fluid component in the input fluid stream. The process also comprises collecting the rejection product fluid stream, and forming an adsorbed product fluid stream. The molar ratio of the first fluid component to the second fluid component in the adsorbed product stream is greater than the molar ratio of the first fluid component to the second fluid component in the input fluid stream. The process further comprises collecting the adsorbed product stream. The zeolite ITQ-55 has a mean crystal particle size within the range of from about 0.01 microns to about 40 microns. The input fluid stream is exposed to the zeolite ITQ-55 at effective conditions for performing a kinetic separation, in which the kinetic separation exhibits greater kinetic selectivity for first fluid component than for the second fluid component.

It has been surprisingly found that, in accordance with this disclosure, in a process for removing impurities such as nitrogen from a hydrocarbon feed stream (e.g., natural gas), a high pressure hydrocarbon product can be produced. The process involves passing a feed stream at feed pressure through a bed of an adsorbent comprising zeolite ITQ-55 to adsorb nitrogen from the feed stream, thereby producing a product stream, depleted in nitrogen, at feed pressure without need of recompression.

It has also been surprisingly found that, in accordance with this disclosure, zeolite ITQ-55 having a mean crystal particle size within the range of from about 0.01 microns to about 40 microns, exhibits high kinetic selectivity discriminating between nitrogen and methane in natural gas processing. In particular, when a feed stream is exposed to the zeolite ITQ-55 at effective conditions for performing a kinetic separation, the kinetic separation exhibits greater kinetic selectivity for nitrogen than for methane.

Other objects and advantages of the present disclosure will become apparent from the detailed description that follows.

### BRIEF DESCRIPTION OF THE DRAWINGS

FIG. 1 shows scanning electron microscope (SEM) images of zeolite LTQ-55 having a crystal size distribution of 2-30 microns, and mean of 10 microns, in accordance with the Examples.

FIG. 2 graphically shows CH₄ and N₂ uptake on zeolite ITQ-55 having a crystal size distribution of 2-30 microns, and mean of 10 microns at 25° C. and 1 bar (˜14.7 psi), in accordance with the Examples.

FIG. 3 shows CH₄ and N₂ isotherms on zeolite ITQ-55. The symbol ∘ shows CH₄ data measured on zeolite ITQ-55 nanocrystals (<0.01 microns), and the symbol ⋄ shows N₂ data on zeolite ITQ-55 having a crystal size distribution of 2-30 microns, and mean of 10 microns, in accordance with the Examples.

FIG. 4 shows the effect of dehydration temperature on adsorption and diffusion of N₂ and CH₄ in a barium-exchanged Engelhard titanosilicate (i.e., Ba-ETS-4) at 10° C. (from Adsorption and diffusion of methane and nitrogen in barium exchanged ETS-4, Ind. Chem. Eng. Res., 50, 3021-3034, 2011).

FIG. 5 shows fractional uptake of N₂ and CH₄ at 1 bar (˜14.7 psi) and 25C° on zeolite ITQ-55 having a crystal size distribution of 2-30 microns, in accordance with the Examples.

FIG. 6 shows a scanning electron microscope (SEM) image for zeolite ITQ-55 having a crystal size from about 1-2 microns, in accordance with the Examples.

FIG. 7 shows uptakes of CH₄ on zeolite ITQ-55 having a crystal size of about 10 microns and 1 micron separately at 1 bar (˜14.7 psi) and 25° C., in accordance with the Examples.

FIG. 8 shows uptake analysis for CH₄ on zeolite ITQ-55 having a crystal size of about 1-2 microns, in accordance with the Examples.

FIG. 9 shows N₂ uptakes on zeolite ITQ-55 having a crystal size of about 1 micron at −25° C. and up to 6 bar. The left figure shows N₂ uptakes at various pressures. The right figure shows the isotherm at −25° C. extracted from these N₂ uptakes, in accordance with the Examples.

FIG. 10 shows a schematic diagram of 2 bed 6-step pressure swing adsorption (PSA) process, in accordance with the Examples.

FIG. 11 shows the operating sequence for bed 1 and bed 2 in FIG. 10 consisting of six operating steps in a PSA cycle, in accordance with the Examples.

FIG. 12 summarizes the representative simulation results for cases with different PSA stream conditions and separation performance, in accordance with the Examples.

FIG. 13 shows a 2-bed 4-step dual reflux PSA cycle, in accordance with the Examples.

FIG. 14 shows the operating sequence for bed 1 and bed 2 consisting of four operating steps in a PSA cycle in FIG. 13, in accordance with the Examples.

FIG. 15 summarizes the simulation results for cases with dual reflux PSA stream conditions and separation performance, in accordance with the Examples.

FIG. 16 represents the X-ray diffraction (XRD) pattern of the most characteristic peaks of the ITQ-55 material, as is synthesized and in calcined state, obtained according to Example 2.

FIG. 17 shows a field emission scanning electron microscopy (FE-SEM) image of the crystal size and morphology of the ITQ-55 crystals, obtained according to Example 2.

FIG. 18 represents the framework structure of ITQ-55 showing only the tetrahedral atoms.

FIG. 19 is a representation of one embodiment of a parallel channel contactor in the form of a monolith directly formed from a microporous adsorbent and containing a plurality of parallel channels.

FIG. 20 is a cross-sectional representation along the longitudinal axis of the monolith of FIG. 19.

FIG. 21 is a representation of a magnified section of the cross-sectional view of the monolith of FIG. 19 showing the detailed structure of the adsorbent layer along with a blocking agent occupying some of the mesopores and macropores.

FIG. 22 is another representation of an embodiment of a parallel channel contactor in the form of a coated monolith where the adsorbent layer is coated onto the channel wall.

FIG. 23 is a representation of an embodiment of a parallel contactor that is constructed from parallel laminate sheets.

FIG. 24 is a schematic for a high pressure breakthrough apparatus, in accordance with the Examples.

FIG. 25 graphically depicts a comparison of the breakthrough of N₂/CH₄ mixture in ITQ-55 bed and blank bed without bed, in accordance with the Examples.

FIG. 26 is a scanning electron microscope (SEM) image for ITQ-55 with thin plate morphology, in accordance with the Examples.

FIG. 27 graphically depicts the uptake of CH₄ in ITQ-55 samples with thin plate morphology, in accordance with the Examples.

FIG. 28 graphically depicts the uptake of C₂H6 in ITQ-55 samples with thin plate morphology at 25° C., in accordance with the Examples.

FIG. 29 shows a comparison of ETS-4 adsorbents and zeolite ITQ-55 in which the ETS-4 adsorbents show lower CH₄ purity in the product compared to zeolite ITQ-55, in accordance with the Examples.

### DETAILED DESCRIPTION

As used herein, “kinetic selectivity” refers to properties shown by molecular sieve materials in which the difference in the sorption kinetics of molecules of a different size or mass is used to select one species over another. The kinetic selectivity is the ratio of diffusivities of the molecules (e.g., nitrogen and methane). The kinetic selectivity of zeolite ITQ-55 is exploited in swing adsorption processes for gas separation applications, In accordance with this disclosure, zeolite ITQ-55 having a mean crystal particle size within the range of from about 0.01 microns to about 40 microns, exhibits high kinetic selectivity discriminating between nitrogen and methane in natural gas processing.

As used herein, “kinetic activity” refers to the rate of adsorption/desorption shown by molecular sieve materials in which the difference in the sorption kinetics of molecules of a different diffusivities, size or mass is used to select one species over another. The kinetic activity of zeolite ITQ-55 is exploited in swing adsorption processes for gas separation applications. in accordance with this disclosure, for zeolite ITQ-55 having a mean crystal particle size within the range of from about 0.01 microns to about 40 microns, the rate of nitrogen uptake is faster than the rate of methane uptake.

This disclosure relates to the use of a microporous crystalline material of zeolitic nature, identified as “zeolite ITQ-55”, to remove nitrogen by kinetic separation for natural gas processing and other applications.

As used herein, ITQ-55 (INSTITUTO DE TECNOLOGÍA QUIMICA number 55) refers to a crystalline microporous material having a framework of tetrahedral atoms connected by bridging atoms, the tetrahedral atom framework being defined by the interconnections between the tetrahedrally coordinated atoms in its framework, as described in U.S. Patent Application Publication No. 2016/00095663, the disclosure of which is incorporated herein by reference in its entirety. ITQ-55 is stable to calcination in air.

This material, both in its calcined form and synthesized without calcining has an X-ray diffraction pattern that is different from other well-known zeolitic material and, therefore, is characteristic of this material.

In various aspects, the material is suitable for use in separations based on selective adsorption of fluid components. In various aspects, the material is suitable for use in membrane separations of fluid components. In various aspects, the material is suitable for use for storage of a fluid component.

The composition and preparation of ITQ-55 are described, for example, in U.S. Patent Application Publication Nos. 2016/0008753, 2016/0008754, 2016/0008756, 2016/0009563, and 2016/0009618, the disclosures of which are all incorporated herein by reference in their entirety.

The ITQ-55 material used in this disclosure may be pelletized in accordance with well- known techniques.

This disclosure refers to the use of the ITQ-55 microporous crystalline material for separation and adsorption applications.

For its use in separation and adsorption applications, it is preferable that ITQ-55 is in its calcined form without organic matter in its interior.

The ITQ-55 material used in adsorption/separation processes may be in its purely siliceous form, that is to say, not containing elements other than silicon and oxygen in its composition.

The ITQ-55 material used in adsorption/separation processes may be in silica-germania form, that is to say, not containing elements other than silicon, germanium and oxygen in its composition.

The ITQ-55 material is particularly appropriate for use as selective adsorbent of N₂ in the presence of hydrocarbons, preferably methane, ethane, ethylene and combinations of the same, in streams that contain these gases, well as adsorbent in powdered or pelletized form or in membrane form.

According to one specific embodiment, the ITQ-55 material may be used for the separation of N₂ from methane.

Throughout the description and the claims the word “includes” and its variants does not seek to exclude other technical characteristics, additives, components or steps. For the experts in the matter, other objects, advantages and characteristic of the disclosure shall come partly from the description and partly from the practice of the disclosure.

### Separation Process and Method of Use Overview

In this discussion, a fluid is defined as a gas or a liquid, including mixtures of both gas and liquid. In this discussion, ambient temperature generally refers to a pressure of about 1 atmosphere (about 101 kPa) and a temperature of about 20° C.

In various aspects, processes are provided that implement a molecular sieve corresponding to zeolite ITQ-55 as described herein for adsorption and/or separation of components of fluid streams, such as gas streams, liquid streams, or streams corresponding to a mixture of gas and liquid. The zeolite ITQ-55 can be suitable for separating a variety of small molecules. At some temperatures, a molecular sieve corresponding to zeolite ITQ-55 can be suitable for adsorbing a variety of small molecules while reducing, minimizing, or even substantially eliminating adsorption of methane and other compounds containing at least one methyl group. For example, zeolite ITQ-55 can be suitable for performing separations to separate N₂ from methane. A variety of other types of fluid separations can also be performed depending on the composition of an input gas and the temperature and pressure during the separation process.

The pore structure of zeolite ITQ-55 includes 8-member ring channels. The 8-member ring channels include a minimum pore channel size in the pore network of 5.9 Angstroms×2.1 Angstroms at ambient temperature. This minimum pore channel size can limit the types of compounds that can effectively enter and/or pass through the pore network. However, the 8-member ring that provides the minimum size is also believed to have flexibility. This flexibility can allow the 8-member ring to deform, such as due to thermal fluctuations and/or due to fluctuations induced at elevated pressures, which can lead to a potential temporary change in the size of the pore channel. Without being bound by any particular theory, it is believed that the flexibility of the 8-member ring defining the size of the pore channel can allow for additional tuning of separations of various compounds based on temperature and/or pressure.

Additionally or alternately, the particle size of ITQ-55 crystals used in an adsorbent structure or membrane structure can have an impact on the ability of the adsorbent structure or membrane structure to perform a separation. As one example, the particle size of the ITQ-55 crystals can have an influence on the amount of “dead space” that is present at the surface and/or within the interior of an adsorbent structure or membrane structure. Mathematically, the packing density of a collection of hard spheres of similar size is dependent on the radius of the spheres. For a collection of hard spheres, the larger the average radius, the larger the size of the spaces or gaps between the hard spheres. Without being bound by any particular theory, it is believed that for a collection of ITQ-55 crystals of similar size, the size of the voids or dead spaces created after close packing of crystals can be related to the average particle size. Having a smaller particle size can reduce such dead space, thus providing an increased pore surface area for accepting fluid components for separation.

In an embodiment, the zeolite ITQ-55 can be used in an adsorbent structure (e.g., adsorbent bed). The zeolite ITQ-55 is made up of zeolite crystal particles having a mean particle size within the range of from about 0.01 to about 40 microns. In one type of aspect, the mean zeolite crystal particle size can optionally be within the range of from about 0.01 to about 20 microns, preferably it is within the range of from about 0.01 to about 10 microns, and most preferably within the range of from about 0.01 to about 2 microns. Alternatively, the mean particle size can advantageously be such that at least 5% of the unit cells of the crystal are at the crystal surface. Optionally, the zeolite crystal particles can have a mean particle size within the range from about 0.05 to about 25 microns, or within the range from about 0.05 to about 10 microns, or within the range of from about 0.05 to about 5 microns, or within the range of from about 0.05 to about 2.5 microns, or within the range of from about 0.05 to about 2 microns.

In such an aspect, the zeolite crystal particle size distribution can be such that 95% of the particles have a size within ±33% of the mean, or 95% are within ±15% of the mean, or 95% are within ±10% of the mean, or 95% are within ±7.5% of the mean, or 95% are within ±5% of the mean, or 95% are within ±2.5% of the mean, or 95% are within ±1% of the mean, or 95% are within ±0.5% of the mean.

In some aspects, the zeolite crystal particles of ITQ-55 can be contiguous in the adsorbent bed, i.e., substantially every particle is in contact with one or more of its neighbors as evidenced by electron microscopy preferably high resolution microscopy, although not necessarily in contact with all its closest neighbors. In a preferred embodiment, the particles in the adsorbent bed are closely packed.

References to zeolite crystal particle size are throughout this specification to the longest dimension of the particle and particle sizes are as measured by direct imaging with electron microscopy. Particle size distribution may be determined by inspection of scanning or transmission electron micrograph images preferably on lattice images, and analyzing an appropriately sized population of particles for particle size.

Additionally or alternately, the composition of ITQ-55 crystals used in an adsorbent structure or membrane structure can have an impact on the ability of the adsorbent structure or the membrane structure to perform a separation. In some aspects, ITQ-55 can be synthesized to have a framework structure composed of primarily silicon and oxygen. In other aspects, a portion of the framework atoms in the ITQ-55 structure can be replaced with other elements. For example, a portion of the silicon in the framework structure can be replaced with atoms from a different group in the periodic table, such as Al, P, or B. As another example, a portion of the silicon in the framework can be replaced with atoms from a different row of the periodic table, such as Ge or P. Such composition variations can modify the size of the pores within the crystal structure and/or modify the affinity of the ITQ-55 relative to one or more potential components for adsorption. Such modifications of pore size and/or affinity can potentially improve selectivity (such as kinetic selectivity) for one or more types of separation.

Zeolite ITQ-55 can be used to separate components in a fluid stream (for example, a gas stream) in various manners. In some aspects, zeolite ITQ-55 can be used to form a membrane structure, so that separation of fluid components is performed by forming a permeate and a retentate portion of a fluid on respective sides of the membrane. Zeolite ITQ-55 can assist with such a membrane separation, for example, by having varying selectivities for allowing fluid components to pass through the membrane.

In other aspects, zeolite ITQ-55 can be used to form an adsorbent structure within a separation vessel, so that separation of fluid components can be performed by adsorbing a portion of a fluid stream within the adsorbent structure while allowing a remainder of the fluid stream to exit from the separation vessel. The adsorbent structure can be composed of the zeolite ITQ-55, or the zeolite ITQ-55 can form a coating as part of an adsorbent structure, so that molecules can pass through the pores of ITQ-55 crystals in order to enter the underlying structure. The zeolite ITQ-55 can assist with performing separations using such an adsorbent structure, for example, by having varying selectivities for allowing fluid components to enter the adsorbent structure.

The composition of ITQ-55, preparation of ITQ-55, and uses of ITQ-55, are described, for example, in U.S. Patent Publication Nos. 2016/0008753, 2016/0008754, 2016/0008756, 2016/0009563, and 2016/0009618, all of which are incorporated herein by reference in their entirety.

### Separation of Fluid Components

Some fluid separations can be performed based on one component of a fluid having a sufficiently small kinetic diameter to enter the pores of zeolite ITQ-55 while a second component is too large to enter the pore network under the exposure conditions. For example, it has been determined that hydrocarbons having a terminal methyl group (including methane) and/or other hydrocarbons containing 3 or more carbon atoms generally have kinetic diameters that are too large to enter and/or pass through the pore network of ITQ-55 at typical ambient conditions, such as about 20° C. and about 0.1 MPaa at a reasonable time for typical crystal sizes above 1 μm. This is in contrast to compounds with a smaller kinetic diameter, such as H₂ or N₂, which can enter and/or pass through the pore network. In this type of situation, a separation can be performed with a high degree of selectivity, as the amount of hydrocarbon entering an ITQ-55 layer can be substantially limited to hydrocarbons that enter at a discontinuity in the ITQ-55 layer, such as a mesopore or macropore at a crystal or grain boundary.

Other types of separations can be dependent on differences in uptake by zeolite ITQ-55 between two (or more) fluid components that have sufficiently small kinetic diameters to enter and/or pass through the pore network of ITQ-55. In this situation, separation of components in an input fluid stream can be performed based on a kinetic separation or an equilibrium separation of the components. The nature of the separation can be dependent on, for example, the relative kinetic diameters of the components and/or the relative affinities of the components for the ITQ-55.

One example of a process where the relationship between the kinetic diameters and/or affinities of molecules and the size of the pore network of a zeolite can be relevant is in selective adsorption of components from a fluid stream. In equilibrium controlled adsorption processes, most of the selectivity is imparted by the equilibrium adsorption properties of the adsorbent, and the competitive adsorption isotherm of a first fluid component in the micropores or free volume of the adsorbent is not favored relative to a second component. In kinetically controlled processes, most of the selectivity is imparted by the diffusional properties of the adsorbent and the transport diffusion coefficient in the micropores and free volume of the competing adsorbed components. In some kinetically controlled processes, a component with a higher diffusivity can be preferentially adsorbed relative to a component with a lower diffusivity. Additionally or alternately, the relative affinity of competing adsorbed components for ITQ-55 can be a factor, which may alter the selectivity for separation of components relative to an expected selectivity based just on diffusivity. Also, in kinetically controlled processes with microporous adsorbents, diffusional selectivity can arise from diffusion differences in the micropores of the adsorbent and/or from selective diffusional surface resistance in the crystals or particles that make-up the adsorbent.

In some aspects, the selectivity of an adsorbent can additionally or alternatively be characterized based on a “kinetic selectivity” for two or more fluid components. As used herein, the term “kinetic selectivity” is defined as the ratio of single component diffusion coefficients, D (in m²/sec), for two different species. These single component diffusion coefficients are also known as the transport diffusion coefficients that are measured for a given adsorbent for a given pure gas component. Therefore, for example, the kinetic selectivity for a particular adsorbent for component A with respect to component B would be equal to D_{A}/D_{B}. The single component diffusion coefficients for a material can be determined by tests well known in the adsorptive materials art. The preferred way to measure the kinetic diffusion coefficient is with a frequency response technique described by Reyes et al. in “Frequency Modulation Methods for Diffusion and Adsorption Measurements in Porous Solids”, J. Phys. Chem. B. 101, pages 614-622, 1997.

In other aspects, the selectivity of an adsorbent can additionally or alternatively be characterized based on an “equilibrium selectivity” for two or more fluid components. As used herein, the term “equilibrium selectivity” is defined in terms of the slope of the single component uptake into the adsorbent (in μmol/g) vs. pressure (in torr) in the linear portion, or “Henry's regime”, of the uptake isotherm for a given adsorbent for a given pure component. The slope of this line is called herein the Henry's constant or “equilibrium uptake slope”, or “H”. The “equilibrium selectivity” is defined in terms of a binary (or pairwise) comparison of the Henrys constants of different components in the feed for a particular adsorbent. Therefore, for example, the equilibrium selectivity for a particular adsorbent for component A with respect to component B would be H_{A}/H_{B}.

Examples of separations that can be performed (either via adsorption or membrane separation) include, but are not limited to:
a) Separation of N₂ from methane, natural gas, flue gas, natural gas liquids (C₂+), other hydrocarbons, and/or other organic compounds having three or more heavy atoms under kinetic separation conditions. Due to the low or minimal adsorption of hydrocarbons by ITQ-55, this separation can be performed under any convenient conditions, so long as the temperature is low enough to substantially minimize adsorption of hydrocarbons. The separation can be performed at any convenient operating conditions based on kinetic selectivity. This can be in contrast to conventional methods for separation of N₂ from hydrocarbons or organic compounds, as conventional methods often involve separation at cryogenic conditions. It is noted that for natural gas, separation of N₂ from natural gas can be performed prior to liquefying the natural gas, after liquefying the natural gas, or a combination thereof.
b) Separation of N₂ from methane and other higher molecular weight hydrocarbons in a natural gas feedstream under kinetic separation conditions.
c) Flue gas separations. One example is a separation of N₂ from CO₂ and other flue gas components, which can be facilitated by the kinetic separation of N₂ from CO₂ and other flue gas components, by ITQ-55 under kinetic separation conditions.
d) Syngas separations. One example is a separation of N₂ from other syngas components, which can be facilitated by the kinetic separation of N₂ from other syngas components, by ITQ-55 under kinetic separation conditions.

### Adsorption Separations (Including Swing Processing)

Gas separation (or other fluid separation) is important in various industries and can typically be accomplished by flowing a mixture of gases over an adsorbent that preferentially adsorbs a more readily adsorbed component relative to a less readily adsorbed component of the mixture. Swing adsorption is an example of a commercially valuable separation technique, such as pressure swing adsorption (PSA) or temperature swing adsorption (TSA). PSA processes rely on the fact that under pressure fluids tend to be adsorbed within the pore structure of a microporous adsorbent material or within the free volume of a polymeric material. The higher the pressure, the more fluid is adsorbed. When the pressure is reduced, the fluid is released, or desorbed. PSA processes can be used to separate fluids in a mixture because different fluids tend to fill the micropore or free volume of the adsorbent to different extents. If a gas mixture, such as natural gas, for example, is passed under pressure through a vessel containing polymeric or microporous adsorbent that fills with more nitrogen than it does methane, part or all of the nitrogen will stay in the adsorbent bed, and the gas coming out of the vessel will be enriched in methane. When the adsorbent bed reaches the end of its capacity to adsorb nitrogen, it can be regenerated by reducing the pressure, thereby releasing the adsorbed nitrogen. It is then ready for another cycle.

A PSA process aimed at the recovery of the lighter species in the light product stream is significantly improved if it is also designed to simultaneously enrich the heavier species in the heavy product stream. Sometimes, a higher enrichment of the heavier species in the heavy product stream leads to higher recoveries of the lighter species in the light product stream. The enrichment of the heavier species in the heavy product stream, and hence the recovery of the lighter species in the light product stream, also increases by decreasing the pressure within the bed during the PSA cycle using PSA cycle steps that are particularly designed for this purpose.

One such step is the equalization step, in which two adsorbent beds of the PSA process are connected at a given moment during the PSA cycle to equalize their own pressures to a common value. This is done sometime before the final depressurization of the bed and most commonly through the light ends of the beds. The content of the lighter species in the beds is reduced because the gas stream leaving the beds is comparably much richer in these species.

Another important fluid separation technique is temperature swing adsorption (TSA). TSA processes also rely on the fact that under pressure fluids tend to be adsorbed within the pore structure of a microporous adsorbent material or within the free volume of a polymeric material.

When the temperature of the adsorbent is increased, the fluid is released, or desorbed. By cyclically swinging the temperature of adsorbent beds, TSA processes can be used to separate fluids in a mixture when used with an adsorbent that selectively picks up one or more of the components in the fluid mixture.

Various types swing adsorption can be used in the practice of the present disclosure. Non-limiting examples of such swing adsorption processes include thermal swing adsorption (TSA) and various types of pressure swing adsorption processes including conventional pressure swing adsorption (PSA), and partial pressure swing or displacement purge adsorption (PPSA) technologies. These swing adsorption processes can be conducted with rapid cycles, in which case they are referred to as rapid cycle thermal swing adsorption (RCTSA), rapid cycle pressure swing adsorption (RCPSA), and rapid cycle partial pressure swing or displacement purge adsorption (RCPPSA) technologies. The term swing adsorption processes shall be taken to include all of these processes (i.e., TSA, PSA, PPSA, RCTSA, RCPSA, and RCPPSA) including combinations of these processes. Such processes require efficient contact of a gas mixture with a solid adsorbent material.

Although any suitable adsorbent contactor can be used in the practice of the present disclosure, including conventional adsorbent contactors, in some aspects structured parallel channel contactors can be utilized. The structure of parallel channel contactors, including fixed surfaces on which the adsorbent or other active material is held, can provide significant benefits over previous conventional gas separation methods, such as vessels containing adsorbent beads or extruded adsorbent particles. With parallel channel contactors, total recovery of the light component (i.e., the component that is not preferentially adsorbed) achieved in a swing adsorption process can be greater than about 80 vol %, or greater than about 85 vol %, or greater than about 90 vol %, or greater than about 95 vol % of the content of the light component introduced into the process. Recovery of the light component is defined as the time averaged molar flow rate of the light component in the product stream divided by the time averaged molar flow rate of the light component in the feedstream. Similarly, recovery of the heavy component (i.e., the component that is preferentially adsorbed) is defined as the time averaged molar flow rate of the heavy component in the product stream divided by the time averaged molar flow rate of the heavy component in the feedstream.

The channels, also sometimes referred to as “flow channels”, “fluid flow channels”, or “gas flow channels”, are paths in the contactor that allow gas or other fluids to flow through. Generally, flow channels provide for relatively low fluid resistance coupled with relatively high surface area. Flow channel length should be sufficient to provide the mass transfer zone which is at least, a function of the fluid velocity, and the surface area to channel volume ratio . The channels are preferably configured to minimize pressure drop in the channels. In many embodiments, a fluid flow fraction entering a channel at the first end of the contactor does not communicate with any other fluid fraction entering another channel at the first end until the fractions recombine after exiting at the second end. It is important that there be channel uniformity to ensure that substantially all of the channels are being fully utilized, and that the mass transfer zone is substantially equally contained. Both productivity and gas/fluid purity will suffer if there is excessive channel inconsistency. If one flow channel is larger than an adjacent flow channel, premature product break through may occur, which leads to a reduction in the purity of the product gas to unacceptable purity levels. Moreover, devices operating at cycle frequencies greater than about 50 cycles per minute (cpm) require greater flow channel uniformity and less pressure drop than those operating at lower cycles per minute. Further, if too much pressure drop occurs across the bed, then higher cycle frequencies, such as on the order of greater than 100 cpm, are not readily achieved.

The dimensions and geometric shapes of the parallel channel contactors can be any dimension or geometric shape that is suitable for use in swing adsorption process equipment. Non- limiting examples of geometric shapes include various shaped monoliths having a plurality of substantially parallel channels extending from one end of the monolith to the other; a plurality of tubular members; stacked layers of adsorbent sheets with and without spacers between each sheet; multi-layered spiral rolls, bundles of hollow fibers, as well as bundles of substantially parallel solid fibers. The adsorbent can be coated onto these geometric shapes or the shapes can, in many instances, be formed directly from the adsorbent material plus suitable binder. An example of a geometric shape formed directly from the adsorbent/binder would be the extrusion of a zeolite/polymer composite into a monolith. Another example of a geometric shape formed directly from the adsorbent would be extruded or spun hollow fibers made from a zeolite/polymer composite. An example of a geometric shape that is coated with the adsorbent would be a thin flat steel sheet that is coated with a microporous, low mesopore, adsorbent film, such as a zeolite film. The directly formed or coated adsorbent layer can be itself structured into multiple layers or the same or different adsorbent materials. Multi-layered adsorbent sheet structures are taught in U.S. Patent Application Publication No. 2006/0169142, which is incorporated herein by reference.

An example of a process where an adsorbent structure comprising ITQ-55 can be used is a swing adsorption process. A swing adsorption process can include an adsorption step followed by a desorption step to recover the adsorbed component. During the adsorption step, “heavy” components are selectively adsorbed and the weakly adsorbed (i.e., “light”) components pass through the bed to form the product gas. It is possible to remove two or more contaminants simultaneously but for convenience, the component or components, that are to be removed by selective adsorption will be referred to in the singular and referred to as a contaminant or heavy component. In a swing adsorption process, the gaseous mixture is passed over a first adsorption bed in a first vessel and a light component enriched product stream emerges from the bed depleted in the contaminant, or heavy component, which remains adsorbed in the bed. After a predetermined time or, alternatively when a break-through of the contaminant or heavy component is observed, the flow of the gaseous mixture is switched to a second adsorption bed in a second vessel for the purification to continue. While the second bed is in adsorption service, the adsorbed contaminant, or heavy component is removed from the first adsorption bed by a reduction in pressure. In some embodiments, the reduction in pressure is accompanied by a reverse flow of gas to assist in desorbing the heavy component. As the pressure in the vessels is reduced, the heavy component previously adsorbed in the bed is progressively desorbed to a heavy component enriched product stream. When desorption is complete, the sorbent bed may be purged with an inert gas stream, e.g., a purified stream of process gas. Purging may also be facilitated by the use of a purge stream that is higher in temperature than the process feedstream.

After breakthrough in the second bed and after the first bed has been regenerated so that it is again ready for adsorption service, the flow of the gaseous mixture is switched back to the first bed, and the second bed is regenerated. The total cycle time is the length of time from when the gaseous mixture is first conducted to the first bed in a first cycle to the time when the gaseous mixture is first conducted to the first bed in the immediately succeeding cycle, i.e., after a single regeneration of the first bed. The use of third, fourth, fifth, etc. vessels in addition to the second vessel can serve to increase cycle time when adsorption time is short but desorption time is long.

In some aspects, an RCPSA process can be used for separation. The total cycle times of RCPSA may be less than about 600 seconds, preferably less than about 60 seconds, more preferably less than about 30 seconds. Further, the rapid cycle pressure swing adsorption units can make use of substantially different sorbents, such as, but not limited to, structured materials such as monoliths, laminates, and hollow fibers.

An adsorbent contactor may optionally contain a thermal mass (heat transfer) material to help control heating and cooling of the adsorbent of the contactor during both the adsorption step and desorption step of a pressure swing adsorption process. Heating during adsorption is caused by the heat of adsorption of molecules entering the adsorbent. The optional thermal mass material also helps control cooling of the contactor during the desorption step. The thermal mass can be incorporated into the flow channels of the contactor, incorporated into the adsorbent itself, or incorporated as part of the wall of the flow channels. When it is incorporated into the adsorbent, it can be a solid material distributed throughout the adsorbent layer or it can be included as a layer within the adsorbent. When it is incorporated as part of the wall of the flow channel, the adsorbent is deposited or formed onto the wall. Any suitable material can be used as the thermal mass material in the practice of the present disclosure. Non-limiting examples of such materials include metals, ceramics, and polymers. Non-limiting examples of preferred metals include steel alloys, copper, and aluminum. Non-limiting examples of preferred ceramics include silica, alumina, and zirconia. An example of a preferred polymer that can be used in the practice of the present disclosure is polyimide. Depending upon the degree to which the temperature rise is to be limited during the adsorption step, the amount of thermal mass material used can range from about 0 to about 25 times the mass of the microporous adsorbent of the contactor. A preferred range for the amount of thermal mass in the contactor is from about 0 to 5 times the mass of the microporous adsorbent of the contactor. A more preferred range for the amount of thermal mass material will be from about 0 to 2 times the mass of the microporous adsorbent material, most preferably from about 0 to 1 times the mass of the microporous material of the contactor.

The overall adsorption rate of the swing adsorption processes is characterized by the mass transfer rate from the flow channel into the adsorbent. It is desirable to have the mass transfer rate of the species being removed (i.e., the heavy component) high enough so that most of the volume of the adsorbent is utilized in the process. Since the adsorbent selectively removes the heavy component from the gas stream, inefficient use of the adsorbent layer can lower recovery of the light component and/or decrease the purity of the light product stream. With use of the adsorbent contactors described herein, it is possible to formulate an adsorbent with a low volume fraction of meso and macroporous such that most of the volume of the adsorbent, which will be in the microporous range, is efficiently used in the adsorption and desorption of the heavy component. One way of doing this is to have an adsorbent of substantially uniform thickness where the thickness of the adsorbent layer is set by the mass transfer coefficients of the heavy component and the time of the adsorption and desorption steps of the process. The thickness uniformity can be assessed from measurements of the thickness of the adsorbent or from the way in which it is fabricated. It is preferred that the uniformity of the adsorbent be such that the standard deviation of its thickness is less than about 25% of the average thickness. More preferably, the standard deviation of the thickness of the adsorbent is less than about 15% of the average thickness. It is even more preferred that the standard deviation of the adsorbent thickness be less than about 5% of the average thickness.

Calculation of these mass transfer rate constants is well known to those having ordinary skill in the art and may also be derived by those having ordinary skill in the art from standard testing data. D. M. Ruthven & C. Thaeron, Performance of a Parallel Passage Absorbent Contactor, Separation and Purification Technology 12 (1997) 43-60, which is incorporated herein by reference, clarifies many aspects of how the mass transfer is affected by the thickness of the adsorbent, channel gap and the cycle time of the process. Also, U.S. Pat. No. 6,607,584 to Moreau et al., which is also incorporated by reference, describes the details for calculating these transfer rates and associated coefficients for a given adsorbent and the test standard compositions used for conventional PSA.

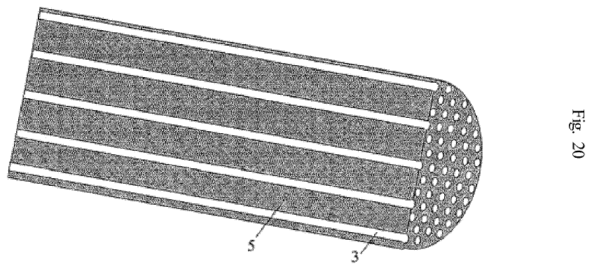

FIG. 19 hereof is a representation of a parallel channel contactor in the form of a monolith formed directly from a microporous adsorbent plus binder and containing a plurality of parallel flow channels. A wide variety of monolith shapes can be formed directly by extrusion processes. An example of a cylindrical monolith 1 is shown schematically in FIG. 19 hereof. The cylindrical monolith 1 contains a plurality of parallel flow channels 3. These flow channels 3 can have channel gaps from about 5 to about 1,000 microns, preferably from about 50 to about 250 microns, as long as all channels of a given contactor have substantially the same size channel gap.

The channels can be formed having a variety of shapes including, but not limited to, round, square, triangular, and hexagonal. The space between the channels is occupied by the adsorbent 5. As shown the channels 3 occupy about 25% of the volume of the monolith and the adsorbent 5 occupies about 75% of the volume of the monolith. The adsorbent 5 can occupy from about 50% to about 98% of the volume of the monolith. The effective thickness of the adsorbent can be defined from the volume fractions occupied by the adsorbent 5 and channel structure as:

Effective Thickness of Adsorbent=½Channel Diameter*(Volume Fraction of Adsorbent)/(Volume Fraction of Channels)

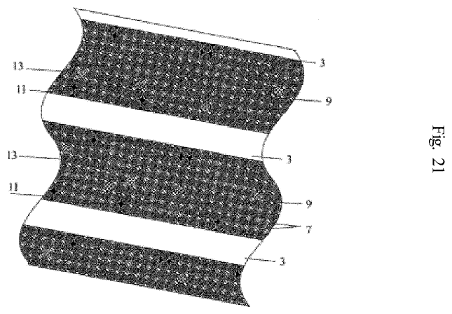

For the monolith of FIG. 19 hereof the effective thickness of the adsorbent will be about 1.5 times the diameter of the feed channel. When the channel diameter is in a range from about 50 to about 250 microns it is preferred that the thickness of the adsorbent layer, in the case wherein the entire contactor is not comprised of the adsorbent, be in a range from about 25 to about 2,500 microns. For a 50 micron diameter channel, the preferred range of thickness for the adsorbent layer is from about 25 to about 300 microns, more preferred range from about 50 to about 250 microns. FIG. 25 is a cross-sectional view along the longitudinal axis showing feed channels 3 extending through the length of the monolith with the walls of the flow channels formed entirely from adsorbent 5 plus binder. A schematic diagram enlarging a small cross section of the feed channels 3 and adsorbent layer 5 of FIG. 20 is shown in FIG. 21 hereof. The adsorbent layer is comprised of a microporous adsorbent, or polymeric, particles 7; solid particles (thermal mass) 9;

that act as heat sinks, a blocking agent 13 and open mesopores and micropores 11. As shown, the microporous adsorbent or polymeric particles 7 occupy about 60% of the volume of the adsorbent layer and the particles of thermal mass 9 occupy about 5% of the volume. With this composition, the voidage (flow channels) is about 55% of the volume occupied by the microporous adsorbent or polymeric particles. The volume of the microporous adsorbent 5 or polymeric particles 7 can range from about 25% of the volume of the adsorbent layer to about 98% of the volume of the adsorbent layer. In practice, the volume fraction of solid particles 9 used to control heat will range from about 0% to about 75%, preferably about 5% to about 75%, and more preferably from about 10% to about 60% of the volume of the adsorbent layer. A blocking agent 13 fills the desired amount of space or voids left between particles so that the volume fraction of open mesopores and macropores 11 in the adsorbent layer 5 is less than about 20%.

When the monolith is used in a gas separation process that relies on a kinetic separation (predominantly diffusion controlled) it is advantageous for the microporous adsorbent or polymeric particles 7 to be substantially the same size. It is preferred that the standard deviation of the volume of the individual microporous adsorbent or polymeric particles 7 be less than 100% of the average particle volume for kinetically controlled processes. In a more preferred embodiment the standard deviation of the volume of the individual microporous adsorbent or polymeric particles 7 is less than 50% of the average particle volume. The particle size distribution for zeolite adsorbents can be controlled by the method used to synthesize the particles. It is also possible to separate pre-synthesized microporous adsorbent particles by size using methods such as a gravitational settling column. It may also be advantageous to use uniformly sized microporous adsorbent or polymeric particles in equilibrium controlled separations.

There are several ways that monoliths can be formed directly from a structured microporous adsorbent. For example, when the microporous adsorbent is a zeolite, the monolith can be prepared by extruding an aqueous mixture containing effective amounts of a solid binder, zeolite and adsorbent, solid heat control particles, and polymer. The solid binder can be colloidal sized silica or alumina that is used to bind the zeolite and solid heat control particles together. The effective amount of solid binder will typically range from about 0.5 to about 50% of the volume of the zeolite and solid heat control particles used in the mixture. If desired, silica binder materials can be converted in a post processing step to zeolites using hydrothermal synthesis techniques and, as such, they are not always present in a finished monolith. A polymer is optionally added to the mixture for rheology control and to give green extrudate strength. The extruded monolith is cured by firing it in a kiln where the water evaporates and the polymer burns away, thereby resulting in a monolith of desired composition. After curing the monolith, the adsorbent layer 5 will have about 20 to about 40 vol. % mesopores and macropores. A predetermined amount of these pores can be filled with a blocking agent 13, as previously discussed, in a subsequent step such as by vacuum impregnation.

Another method by which a monolith can be formed directly from a microporous adsorbent is by extruding a polymer and microporous adsorbent mixture. Preferred microporous adsorbents for use in extrusion process are carbon molecular sieves and zeolites. Non-limiting examples of polymers suitable for the extrusion process include epoxies, thermoplastics, and curable polymers such as silicone rubbers that can be extruded without an added solvent. When these polymers are used in the extrusion process, the resulting product will preferably have a low volume fraction of mesopores and macropores in the adsorbent layer.

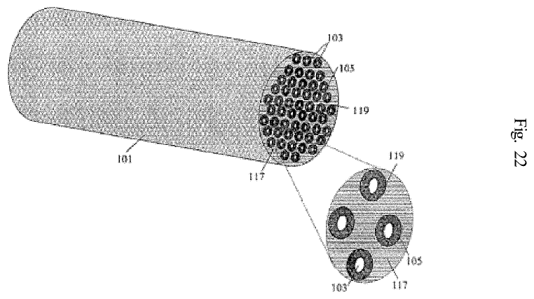

FIG. 22 hereof is a representation of a parallel channel contactor 101 in the form of a coated monolith where an adsorbent layer is coated onto the walls of the flow channels of a preformed monolith. For the parallel channel contactors of FIG. 22, an extrusion process is used to form a monolith from a suitable non-adsorbent solid material, preferably a metal such as steel, a ceramic such as cordierite, or a carbon material. By the term “non-adsorbent solid material” we mean a solid material that is not to be used as the selective adsorbent for the parallel channel contactor. An effective amount and thickness of a ceramic or metallic glaze, or sol gel coating, 119 is preferably applied to effectively seal the channel walls of the monolith. Such glazes can be applied by slurry coating the channel walls, by any suitable conventional means, followed by firing the monolith in a kiln.

Another approach is to apply a sol gel to the channel walls followed by firing under conditions that densify the coating. It is also possible to use vacuum and pressure impregnation techniques to apply the glaze or sol gel to the channel walls. In such a case, the glaze or sol gel will penetrate into the pore structure of the monolith 117. In all cases, the glaze seals the wall of the channel such that gas flowing through the channel is not readily transmitted into the body of the monolith. An adsorbent layer 105 is then uniformly applied onto the sealed walls of the channels. The adsorbent layer 105 reduces the opening, or bore, of the channels, thus the flow channel 103 used in swing adsorption processes is the open channel left inside of the coating. These flow channels 103 can have channel gaps as previously defined. The adsorbent layer 105 can be applied as a coating, or layer, on the walls of the flow channels by any suitable method. Non-limiting examples of such methods include fluid phase coating techniques, such as slurry coating and slip coating. The coating solutions can include at least the microporous adsorbent or polymeric particles, a viscosifying agent such as polyvinyl alcohol, heat transfer (thermal mass) solids, and optionally a binder. The heat transfer solid may not be needed because the body of the monolith 101 can act to as its own heat transfer solid by storing and releasing heat in the different steps of the separation process cycle. In such a case, the heat diffuses through the adsorbent layer 105 and into the body of the monolith 101. If a viscosifying agent, such as polyvinyl alcohol, is used it is usually burns away when the coating is cured in a kiln. It can be advantageous to employ a binder such as colloidal silica or alumina to increase the mechanical strength of the fired coating.

Mesopores or macropores will typically occupy from about 20 to about 40% of the volume of the cured coating. An effective amount of blocking agent is applied to complete the adsorbent layer for use. By effective amount of blocking agent we mean that amount needed to occupy enough of the mesopores and macropores such that the resulting coating contains less than about 20% of its pore volume in open mesopores and macropores.

If a hydrothermal film formation method is employed, the coating techniques used can be very similar to the way in which zeolite membranes are prepared. An example of a method for growing a zeolite layer is taught in U.S. Pat. No. 7,049,259, which is incorporated herein by reference. Zeolite layers grown by hydrothermal synthesis on supports often have cracks and grain boundaries that are mesopore and macropore in size. The volume of these pores is often less than about 10 volume % of the film thickness and there is often a characteristic distance, or gap, between cracks. Thus, as-grown films can often be used directly as an adsorbent layer without the need for a blocking agent.

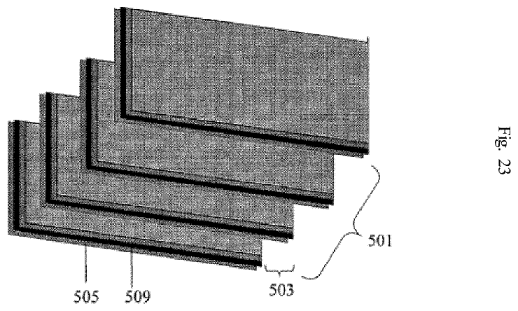

FIG. 23 hereof is a representation of a parallel channel contactor of the present disclosure in which the parallel channels are formed from laminated sheets containing adsorbent material. Laminates, laminates of sheets, or laminates of corrugated sheets can be used in PSA RCPSA, PPSA or RCPPSA processes. Laminates of sheets are known in the art and are disclosed in U.S. Patent Publication No. US2006/0169142 A1 and U.S. Pat. No. 7,094,275 B2, which are incorporated herein by reference. When the adsorbent is coated onto a geometric structure or components of a geometric structure that are laminated together, the adsorbent can be applied using any suitable liquid phase coating techniques. Non-limiting examples of liquid phase coating techniques that can be used in the practice of the present disclosure include slurry coating, dip coating, slip coating, spin coating, hydrothermal film formation and hydrothermal growth. When the geometric structure is formed from a laminate, the laminate can be formed from any material to which the adsorbent of the present disclosure can be coated. The coating can be done before or after the material is laminated. In all these cases the adsorbent is coated onto a material that is used for the geometric shape of the contactor. Non-limiting examples of such materials include glass fibers, milled glass fiber, glass fiber cloth, fiber glass, fiber glass scrim, ceramic fibers, metallic woven wire mesh, expanded metal, embossed metal, surface-treated materials, including surface- treated metals, metal foil, metal mesh, carbon-fiber, cellulosic materials, polymeric materials, hollow fibers, metal foils, heat exchange surfaces, and combinations of these materials. Coated supports typically have two major opposing surfaces, and one or both of these surfaces can be coated with the adsorbent material. When the coated support is comprised of hollow fibers, the coating extends around the circumference of the fiber. Further support sheets may be individual, presized sheets, or they may be made of a continuous sheet of material. The thickness of the substrate, plus applied adsorbent or other materials (such as desiccant, catalyst, etc.), typically ranges from about 10 micrometers to about 2000 micrometers, more typically from about 150 micrometers to about 300 micrometers.

FIG. 23 hereof illustrates an exploded view of an embodiment of the present disclosure wherein a microporous adsorbent film 505 is on each of both faces of flat metal foils 509, which is preferably fabricated from a corrosion resistant metal such as stainless steel. The separate metal foils 509 with the adsorbent films 505 are fabricated to form a parallel channel contactor 501. Spacers of appropriate size may be placed between the metal foils during contactor fabrication so that the channel gap 503 is of a predetermined size. Preferably about half of the volume of the feed channels 503 are filled with a spacer that keeps the sheets substantially evenly spaced apart.

Metallic mesh supports can provide desirable thermal properties of high heat capacity and conductivity which “isothermalize” a PSA, RCPSA, PPSA or RCPPSA cycle to reduce temperature variations that degrade the process when conducted under more adiabatic conditions. Also, metal foils are manufactured with highly accurate thickness dimensional control. The metal foil may be composed of, without limitation, aluminum, steel, nickel, stainless steel or alloys thereof. Hence there is a need for a method to coat metal foils with a thin adsorbent layer of accurately controlled thickness, with necessary good adhesion. One method for doing this is by hydrothermal synthesis. Coating procedures used can be very similar to the way in which zeolite membranes are prepared as discussed above. Zeolite layers grown by hydrothermal synthesis on supports often have cracks which are mesopores and micropores. The volume of these pores is often less than about 10 volume % of the film thickness and there is often a characteristic distance between cracks. Another method of coating a metal foil is with thick film coating is slip casting, or doctor blading. An aqueous slurry of prefabricated zeolite particles, binder (for example colloidal silica or alumina), viscosifying agent such as a polymer like polyvinyl alcohol is cast for example onto a metal foil and fired to remove the polymer and cure the binder and zeolite. The product, after firing, is then a bound zeolite film on a metal foil typically containing about 30 to about 40 volume % voids. To make a suitable adsorbent layer, the voids are filled in a subsequent step by coating the bound zeolite film with a polymer or by introducing a liquid into the voids of the bound zeolite film. The final product, after filling the voids with a polymer or liquid, will be an adsorbent layer having the low mesoporosity and microporosity requirements of the present disclosure.

In some aspects, it would be valuable in the industry to enable the separation of certain contaminants from a natural gas feedstream. One contaminant that is particularly of interest for removal is nitrogen (N₂). The term “natural gas” or “natural gas feedstream” as used herein is meant to cover natural gas as extracted at the well head, natural gas which has been further processed, as well as natural gas for pipeline, industrial, commercial or residential use.

Of particular interest herein, is the use of the ITQ-55 material for removing contaminants from natural gas at wellheads (or after some amount of pre-processing) for further processing of the natural gas to meet the necessary specifications for putting the natural gas into a pipeline or for its intermediate or final industrial, commercial, or residential use. Of particular interest is the ability to remove one or more of these contaminants at the relatively high natural gas well processing pressure conditions. The removal of N₂ from natural gas (i.e., in particular the methane and higher molecular weight hydrocarbon components of the natural gas) is important to remove this inert gas prior to further processing of the natural gas in processes which in turn substantially reduces overall processing facility capacity size requirements, as well as to meet certain specifications on the composition of the natural gas.

It is of substantial benefit if the removal of these contaminants can be done at the relatively high pressures near the natural gas wellhead, as natural gas is usually produced at pressures ranging from 1,500 to 7,000 psi (10.3 MPa-48.3 MPa); and wherein the natural gas feedstream can be fed to the separations processes at over 300 psia (2.1 MPa), 500 psia (3.4 MPa), or even 1000 psia (6.9 MPa), such as up to about 2500 psia (about 17 Mpa) or more. There are few, if any, materials that can operate reliably and effectively to separate these contaminants from methane and other higher molecular weight hydrocarbons under PSA, PPSA, RCPSA, RCPPSA, or TSA (or combined cycle processes such as PSA/TSA, PPSA/TSA, RCPSA/TSA, and RCPPSA/TSA, wherein steps from each process are combined in the overall cycle) cycle conditions at these high pressure conditions. Some of the benefits of being to perform these separations at these high pressures include smaller equipment size (due to the smaller gas volume at high pressures) and the ability to use the product streams from these separations processes in further processing or pipeline transportation without the need for, or the reduced need for, equipment and energy required to repressurize the resulting separations product stream(s) for such further use.

In embodiments herein, the ITQ-55 material can be used in PSA, PPSA, RCPSA, RCPPSA, TSA or combined cycle conditions at natural gas feed pressures in the range of about 15 to about 5.000 psia (about 0.1 MPa to about 35 MPa), about 50 to about 3,000 psia (about 0.34 MPa to about 21 MPa), about 100 to about 2,000 psia (about 0.69 MPa to about 14 MPa), about 250 to about 1,500 psia (about 1.7 MPa to about 10 MPa), over 50 psia (0.34 MPa), over 250 psia (1.7 MPa), over 500 psia (3.4 MPa), or over 1000 psia (6.9 MPa). In embodiments, operating natural gas feed temperatures may be from about -32 to about 300° F. (about −36° C. to about 150° C.).

In an embodiment, using zeolite ITQ-55 in a PSA cycle with binary CH₄/N₂ feed, the CH₄ purity can be at least 80%, or at least 85%, or at least 90%, or at least 95%.

In an embodiment, using zeolite ITQ-55 in a PSA cycle with binary CH₄/N₂ feed, the CH₄ recovery can be at least 75%, or at least 80%, or at least 85%, or at least 90%.

In an embodiment, using zeolite ITQ-55 in a PSA cycle with binary CH₄/N₂ feed, the feed flow rate can range from about 1 million standard cubic feet per day (MSCFD) to about 600 MSCFD, preferably from about 5 MSCFD to about 200 MSCFD, and more preferably from about 10 MSCFD to about 100 MSCFD.

In an embodiment, using zeolite ITQ-55 in a PSA cycle with binary CH₄/N₂ feed, the productivity (ton/day/m³ bed) can range from about 10 ton/day/m³ bed to about 500 ton/day/m³ bed, preferably from about 20 ton/day/m³ bed to about 400 ton/day/m³ bed, and more preferably from about 50 ton/day/m³ bed to about 300 ton/day/m³ bed.

In an embodiment, using zeolite ITQ-55 in a PSA cycle with binary CH₄/N₂ feed, the PSA cycle time can range from about 1 second to about 3600 seconds, preferably from about 5 seconds to about 300 seconds, and more preferably from about 5 seconds to about 60 seconds.

Preferred separation embodiments of this disclosure are described below.

Embodiment 1. A process of adsorbing nitrogen from a feed stream containing hydrocarbons and impurities, wherein the hydrocarbons comprise at least methane and the impurities comprise at least nitrogen and optionally carbon dioxide, said process comprising passing the feed stream through a bed of an adsorbent comprising zeolite ITQ-55 to adsorb nitrogen from the feed stream, thereby producing a high pressure product stream at feed pressure that is depleted in nitrogen; wherein the zeolite ITQ-55 has a mean crystal particle size within the range of from about 0.01 microns to about 40 microns; and wherein the feed stream is exposed to the zeolite ITQ-55 at effective conditions for performing a kinetic separation, in which the kinetic separation exhibits greater kinetic selectivity for nitrogen than for methane.

Embodiment 2. The process of embodiment 1 wherein the feed pressure is from about 13.8 bar (˜200 psi) to about 110 bar (1600 psi), or from about 34.5 bar (˜500 psi) to about 103 bar (1500 psi), or from about 41.4 bar (˜600 psi) to about 96.5 bar (1400 psi).

Embodiment 3. The process of embodiment 1, which is a swing adsorption process comprising an adsorption step performed at elevated pressure and/or reduced temperature in which the feed stream is passed through a bed of adsorbent comprising the zeolite ITQ-55 to adsorb nitrogen from the feed stream, and a desorption step performed at reduced pressure and/or elevated temperature in which nitrogen from the previous adsorption step is desorbed from the bed to regenerate the bed for the next adsorption step.

Embodiment 4. The process of embodiment 3, which is a rapid swing adsorption process.

Embodiment 5. The process of embodiment 4, wherein the rapid swing adsorption process is selected from rapid cycle thermal swing adsorption (RCTSA), rapid cycle pressure swing adsorption (RCPSA), and rapid cycle partial pressure swing adsorption (RCPPSA).

Embodiment 6. The process of embodiment 1, wherein the kinetic separation exhibits greater kinetic selectivity for nitrogen than for methane, at a temperature from about −40° C. to about 50° C.

Embodiment 7. The process of embodiment 1, wherein the kinetic separation exhibits greater kinetic selectivity for nitrogen than for methane, at a pressure of about 1 bar (˜14.7 psi) to about 100 bar (1450 psi).

Embodiment 8. The process of embodiment 1, wherein the zeolite ITQ-55 has a mean crystal particle size within the range of from about 0.01 microns to about 15 microns.

Embodiment 9. The process of embodiment 1, wherein the zeolite ITQ-55 has a mean crystal particle size within the range of from about 0.01 microns to about 2 microns.

Embodiment 10. The process of embodiment 1, wherein the kinetic separation exhibits faster kinetic activity for nitrogen than for methane.

Embodiment 11. The process of embodiment 8, wherein the kinetic separation exhibits faster kinetic activity for nitrogen than for methane, at a temperature from about −10° C. to about 30° C.

Embodiment 12. The process of embodiment 8, wherein the kinetic separation exhibits faster kinetic activity for nitrogen than for methane, at a pressure of about 2 bar (˜29 psi) to about 100 bar (˜1450 psi).

Embodiment 13. The process of embodiment 1, wherein the feed stream comprises natural gas, a hydrocarbon stream containing nitrogen and optionally carbon dioxide, or a hydrocarbon stream containing nitrogen, water and optionally carbon dioxide.

Embodiment 14. The process of embodiment 1, wherein the feed stream is exposed to the adsorbent comprising zeolite ITQ-55 at a pressure of about 25 bar (˜363 psi) to about 100 bar (˜1450 psi).

Embodiment 15. The process of embodiment 1, wherein the feed stream is exposed to the adsorbent comprising zeolite ITQ-55 at a temperature of about −10° C. to about 30° C.

Embodiment 16. The process of embodiment 1, wherein methane recovery in the product stream is greater than about 80%, or greater than about 90%, and methane purity in the product stream is greater than about 90%, or greater than about 95%.

Embodiment 17. A process of adsorbing nitrogen and carbon dioxide from a feed stream containing hydrocarbons and impurities, wherein the hydrocarbons comprise at least methane and the impurities comprise at least nitrogen and carbon dioxide, said process comprising passing the feed stream through one or more beds of adsorbent comprising zeolite ITQ-55; wherein the zeolite ITQ-55 has a mean crystal particle size within the range of from about 0.1 microns to about 40 microns; wherein the feed stream is exposed to the adsorbent at effective conditions for performing a kinetic separation, in which the kinetic separation exhibits greater kinetic selectivity for nitrogen and carbon dioxide than for methane.

Embodiment 18. The process of embodiment 17, wherein the process is a swing adsorption process comprising an adsorption step performed at elevated pressure and/or reduced temperature in which the feed stream is passed through a bed of adsorbent comprising a first adsorbent and a second adsorbent to adsorb nitrogen and carbon dioxide, respectively, thereby producing a product stream enriched in methane and depleted in nitrogen and carbon dioxide, and a desorption step performed at reduced pressure and/or elevated temperature in which nitrogen and carbon dioxide from the previous adsorption step are desorbed from the bed to regenerate the bed for the next adsorption step.

Embodiment 19. The process of embodiment 18, wherein the bed of adsorbent comprises a first layer comprising the first adsorbent and a second layer comprising the second adsorbent, the first and second layers being arranged such that during the adsorption step the feed stream passes through the first layer and contacts the first adsorbent for adsorption of nitrogen before passing through the second layer and contacting the second adsorbent for adsorption of carbon dioxide.

Embodiment 20. The process of embodiment 18, which is a rapid swing adsorption process.

Embodiment 21. The process of embodiment 20, wherein the rapid swing adsorption process is selected from rapid cycle thermal swing adsorption (RCTSA), rapid cycle pressure swing adsorption (RCPSA), and rapid cycle partial pressure swing adsorption (RCPPSA).

Embodiment 22. The process of embodiment 18, wherein the kinetic separation on the first adsorbent exhibits greater kinetic selectivity for nitrogen than for methane, at a temperature from about −40° C. to about 50° C.; and wherein the kinetic separation on the second adsorbent exhibits greater kinetic selectivity for carbon dioxide than for methane, at a temperature from about −40° C. to about 50° C.

Embodiment 23. The process of embodiment 18, wherein the kinetic separation on the first adsorbent exhibits greater kinetic selectivity for nitrogen than for methane, at a pressure of about 1 bar (˜14.7 psi) to about 100 bar (˜1450 psi); and wherein the kinetic separation on the second adsorbent exhibits greater kinetic selectivity for carbon dioxide than for methane, at a pressure of about 1 bar (˜14.7 psi) to about 100 bar (˜1450 psi).

Embodiment 24. The process of embodiment 18, wherein the zeolite ITQ-55 first adsorbent has a mean crystal particle size within the range of from about 0.01 microns to about 15 microns, or from about 0.01 microns to about 5 microns, or from about 0.01 microns to about 2 microns.

Embodiment 25. The process of embodiment 18, wherein the zeolite ITQ-55 second adsorbent has a mean crystal particle size within the range of from about 0.1 microns to about 50 microns, or from about 0.1 microns to about 20 microns, or from about 0.1 microns to about 10 microns.

Embodiment 26. The process of embodiment 18, wherein the kinetic separation on the first adsorbent exhibits faster kinetic activity for nitrogen than for methane; and wherein the kinetic separation on the second adsorbent exhibits faster kinetic activity for carbon dioxide than for methane.

Embodiment 27. The process of embodiment 26, wherein the kinetic separation on the first adsorbent exhibits faster kinetic activity for nitrogen than for methane, at a temperature from about −10° C. to about 30° C.; and wherein the kinetic separation on the second adsorbent exhibits faster kinetic activity for carbon dioxide than for methane, at a temperature from about −10° C. to about 30° C.

Embodiment 28. The process of embodiment 26, wherein the kinetic separation on the first adsorbent exhibits faster kinetic activity for nitrogen than for methane, at a pressure of about 2 bar (˜29 psi) to about 100 bar (˜1450 psi); and wherein the kinetic separation on the second adsorbent exhibits faster kinetic activity for carbon dioxide than for methane, at a pressure of about 1 bar (˜14.7 psi) to about 100 bar (˜1450 psi).

Embodiment 29. The process of embodiment 17, wherein the feed stream comprises natural gas, a hydrocarbon stream containing nitrogen and carbon dioxide, or a hydrocarbon stream containing nitrogen, carbon dioxide and water.

Embodiment 30. The process of embodiment 18, wherein the feed stream is exposed to the first adsorbent comprising zeolite ITQ-55 and the second adsorbent comprising zeolite ITQ-55, at a pressure of about 1 bar (˜14.7 psi) to about 100 bar (˜1450 psi).

Embodiment 31. The process of embodiment 18, wherein the feed stream is exposed to the first adsorbent comprising zeolite ITQ-55 and the second adsorbent comprising zeolite ITQ-55, at a temperature of about −10° C. to about 30° C.

Embodiment 32. The process of embodiment 17, wherein methane recovery in the product stream is greater than about 80%, or greater than about 90%, and methane purity in the product stream is greater than about 90%, or greater than about 95%.

Embodiment 33. A method for separating fluids, comprising:

exposing an input fluid stream comprising a first fluid component and a second fluid component to an adsorbent comprising zeolite ITQ-55 to form a rejection product fluid stream, a molar ratio of the first fluid component to the second fluid component in the rejection product fluid stream being less than a molar ratio of the first fluid component to the second fluid component in the input fluid stream;

collecting the rejection product fluid stream;

forming an adsorbed product fluid stream, a molar ratio of the first fluid component to the second fluid component in the adsorbed product stream being greater than the molar ratio of the first fluid component to the second fluid component in the input fluid stream; and

collecting the adsorbed product stream,

wherein the zeolite ITQ-55 has a mean crystal particle size within the range of from about 0.01 microns to about 40 microns; wherein the input fluid stream is exposed to the zeolite ITQ- 55 at effective conditions for performing a kinetic separation, in which the kinetic separation exhibits greater kinetic selectivity for first fluid component than for the second fluid component.

Embodiment 34. The method of embodiment 33, wherein the first component is nitrogen and optionally carbon dioxide, and the second component is methane.

Embodiment 35. The method of embodiment 33 further comprising producing the rejection product fluid stream at feed pressure.

Embodiment 36. The method of embodiment 35 wherein the feed pressure is from about 13.8 bar (˜200 psi) to about 110 bar (˜1600 psi), or from about 34.5 bar (˜500 psi) to about 103 bar (˜1500 psi), or from about 41.4 bar (˜600 psi) to about 96.5 bar (˜1400 psi).

Embodiment 37. The method of embodiment 33, which is a swing adsorption process comprising an adsorption step performed at elevated pressure and/or reduced temperature in which the feed stream is passed through a bed of adsorbent comprising the zeolite ITQ-55 to adsorb nitrogen from the input fluid stream, and a desorption step performed at reduced pressure and/or elevated temperature in which nitrogen from the previous adsorption step is desorbed from the bed to regenerate the bed for the next adsorption step.

Embodiment 38. The method of embodiment 33, which is a rapid swing adsorption process.

Embodiment 39. The method of embodiment 38, wherein the rapid swing adsorption process is selected from rapid cycle thermal swing adsorption (RCTSA), rapid cycle pressure swing adsorption (RCPSA), and rapid cycle partial pressure swing adsorption (RCPPSA).

Embodiment 40. The method of embodiment 33, wherein the kinetic separation exhibits greater kinetic selectivity for nitrogen than for methane, at a temperature from about −40° C. to about 50° C.

Embodiment 41. The method of embodiment 33, wherein the kinetic separation exhibits greater kinetic selectivity for nitrogen than for methane, at a pressure of about 1 bar (˜14.7 psi) to about 100 bar (˜1450 psi).

Embodiment 42. The method of embodiment 33, wherein the zeolite ITQ-55 has a mean crystal particle size within the range of from about 0.01 microns to about 15 microns.

Embodiment 43. The method of embodiment 33, wherein the zeolite ITQ-55 has a mean crystal particle size within the range of from about 0.01 microns to about 20 microns, or from about 0.01 microns to about 5 microns, or from about 0.01 microns to about 2 microns.

Embodiment 44. The method of embodiment 33, wherein the kinetic separation exhibits faster kinetic activity for nitrogen than for methane.

Embodiment 45. The method of embodiment 44, wherein the kinetic separation exhibits faster kinetic activity for nitrogen than for methane, at a temperature from about −10° C. to about 30° C.

Embodiment 46. The method of embodiment 44, wherein the kinetic separation exhibits faster kinetic activity for nitrogen than for methane, at a pressure of about 2 bar (˜29 psi) to about 100 bar (˜1450 psi).

Embodiment 47. The method of embodiment 33, wherein the first fluid component is N_{2,} or a combination of N₂ and another fluid component.

Embodiment 48. The method of embodiment 33, wherein the first fluid component is

N₂ and optionally CO₂.

Embodiment 49. The method of embodiment 33, wherein the second fluid component is CH₄, a hydrocarbon having a higher molecular weight than CH₄, or a combination thereof.

Embodiment 50. The method of embodiment 33, wherein the second fluid component is CH₄.

Embodiment 51. The method of embodiment 33, wherein the input fluid stream comprises natural gas, a hydrocarbon stream containing nitrogen, or a hydrocarbon stream containing nitrogen and water.

Embodiment 52. The method of embodiment 33, wherein the input fluid stream is exposed to the adsorbent comprising zeolite ITQ-55 at a pressure of about 25 bar (˜363 psi) to about 100 bar (˜1450 psi).

Embodiment 53. The method of embodiment 33, wherein the input stream is exposed to the adsorbent comprising zeolite ITQ-55 at a temperature of about −10° C. to about 40° C.

Embodiment 54. The method of embodiment 33, wherein methane recovery in the rejection product fluid stream is greater than about 80%, or greater than about 90%, and methane purity in the rejection product fluid stream is greater than about 90%, or greater than about 95%.

Embodiment 55. The method of embodiment 33, wherein forming an adsorbed product fluid stream comprises modifying at least one of a temperature or a pressure of the adsorbent.

Separation of N₂ from Methane, Natural Gas, and Other Hydrocarbons

Natural gas deposits can often include nitrogen as part of the total gas composition. Additionally, during extraction of natural gas, nitrogen can be introduced into a well to assist with extraction. This process can sometimes be referred to as “nitrogen flooding”. As a result, natural gas can often include nitrogen as a “contaminant”. Nitrogen is generally not harmful to many natural gas uses, but nitrogen can act as a diluent, reducing the fuel value of a natural gas feed. Thus, it can be beneficial to reduce or minimize the nitrogen content of a natural gas feed.

Nitrogen can be separated from natural gas (or other streams containing alkanes/organic compounds) using an adsorbent and/or membrane that includes zeolite ITQ-55. Adsorption can be performed using any process of this disclosure, such as a swing adsorption process. For separation by adsorption, a natural gas (or other stream containing alkanes/organic compounds) that also contains nitrogen can be exposed to an adsorbent structure. The surface of the adsorbent structure can be composed of and/or include zeolite ITQ-55 in a manner so that fluids that enter the adsorbent structure can enter by passing through pores of the ITQ-55. Depending on the adsorbent structure, defects in the ITQ-55 crystal structure and/or defects between crystals can allow some fluids to enter the adsorbent structure without passing through the ITQ-55. Due to such defects, less than 100% of the fluids entering the adsorbent structure may pass through the ITQ-55 crystals, such as at least about 90 vol %, or at least about 95%, or at least about 98%.

Similarly, for separation by permeation through a membrane, a natural gas (or other stream containing alkanes/organic compounds) that also contains nitrogen can be exposed to a membrane structure. The surface of the membrane structure can be composed of and/or include zeolite ITQ-55 in a manner so that fluids that enter the membrane structure can enter by passing through pores of the ITQ-55. Depending on the adsorbent structure, defects in the ITQ-55 crystal structure and/or defects between crystals can allow some fluids to enter the membrane structure without passing through the ITQ-55. Due to such defects, less than 100% of the fluids entering the membrane structure may pass through the ITQ-55 crystals, such as at least about 90 vol %, or at least about 95%, or at least about 98%.

During a separation process, a fluid comprising natural gas (or other hydrocarbon or organic components) and nitrogen can be exposed to an adsorbent or membrane structure. Based on the kinetic diameter and/or the affinity of nitrogen for the ITQ-55, the nitrogen can preferentially enter the adsorbent or membrane structure relative to methane or other organic compounds. This can allow for kinetic selectivity for nitrogen over methane or another organic compound, either for adsorption or for separation via membrane, of at least about 5, or at least about 10, or at least about 20, or at least about 30.

Optionally, the adsorption separation or membrane can be performed at a temperature below 50° C., such as 30° C. or less, or 0° C. or less, or -30° C. or less, or -50° C. or less. This can enhance the selectivity of the ITQ-55 for performing the separation, as well as potentially increasing the capacity of an adsorbent structure for holding nitrogen. Optionally, performing a separation at low temperature can also benefit from allowing water to be condensed out of a fluid prior to the fluid being exposed to the adsorbent or membrane structure. Optionally, a low temperature separation can be performed at any convenient pressure, such as a pressure of 100 bar (1450 psi) or less. It is noted that at these separation conditions, the fluid being separated can optionally correspond to a liquid.

As another option, the separation can be performed at a temperature of about 30° C. to about −30° C. and at a pressure of about 100 bar (˜1450 psi) or less, or about 75 bar (˜1088 psi) or less, or about 50 bar (˜725 psi) or less. Under these conditions, entry of methane or other organic compounds can be reduced, minimized, or possibly eliminated. The minimized entry of methane or other organic compounds into the adsorbent structure or membrane structure can facilitate performing a separation with high kinetic selectivity.

Illustrative N₂ adsorptive capacity can range from about 0.1 mol/kg to about 2 mol/kg, preferably from about 0.15 mol/kg to about 2 mol/kg, and more preferably from about 0.2 mol/kg to about 2 mol/kg.

Illustrative N₂ adsorption temperature can range from about -50° C. to about 30° C., preferably from about −30° C. to about 25° C., and more preferably from about −10° C. to about 20° C.

Illustrative N₂ desorption temperature can range from about 20° C. to about 100° C., preferably from about 25° C. to about 75° C., and more preferably from about 25° C. to about 50° C.

Illustrative N₂ adsorption pressure can range from about 1 bar (˜14.7 psi) to about 100 bar (1450 psi), preferably from about 10 bar (˜145 psi) to about 90 bar (1305 psi), and more preferably from about 20 bar (˜290 psi) to about 80 bar (˜1160 psi).

Illustrative N₂ desorption pressure can range from about 1 bar (˜14.7 psi) to about 20 bar (˜290 psi), preferably from about 1 bar (˜14.7 psi) to about 10 bar (˜145 psi), and more preferably from about 1 bar (˜14.7 psi) to about 5 bar (˜72.5 psi).

Illustrative N₂ adsorption time can range from about 1 second to about 3600 seconds, preferably from about 5 seconds to about 600 seconds, and more preferably from about 10 seconds to about 180 seconds.

Illustrative N₂ desorption time can range from about 1 second to about 3600 seconds, preferably from about 5 seconds to about 600 seconds, and more preferably from about 10 seconds to about 180 seconds.

Illustrative N₂ content in the feed stream can range from about 2 wt. % to about 30 wt.%, preferably from about 4 wt. % to about 20 wt.%, and more preferably from about 5 wt. % to about 10 wt.%.

In an embodiment, in a process for removing nitrogen from a hydrocarbon feed stream (e.g., natural gas), a high pressure hydrocarbon product can be produced. The process involves passing a feed stream at feed pressure through a bed of an adsorbent comprising zeolite ITQ-55 to adsorb nitrogen from the feed stream, thereby producing a product stream, depleted in nitrogen, at feed pressure without need of recompression.

High feed pressures and product stream pressures useful in the process for removing nitrogen from a hydrocarbon feed stream (e.g., natural gas) in accordance with this disclosure include, for example, feed pressures and product stream pressures ranging from about 13.8 bar (200 psi) to about 110 bar (˜1600 psi), or from about 34.5 bar (˜500 psi) to about 103 bar (˜1500 psi), or from about 41.4 bar (˜600 psi) to about 96.5 bar (˜1400 psi), or from about 55.2 bar (˜800 psi) to about 110 bar (˜1600 psi).

As used herein, N₂ and nitrogen are used interchangeably, CH₄ and methane are used interchangeably, and CO₂ and carbon dioxide are used interchangeably.

The following non-limiting examples are provided to illustrate the disclosure.

### EXAMPLES

### Example 1

### Preparation of Zeolite LTQ-55

Zeolite ITQ-55 samples are prepared in accordance with U.S. Patent Publication No. 2016/0009563. The zeolite ITQ-55 samples have a mean crystal particle size within the range of from about 2-30 microns.

### Example 2

### Preparation of Zeolite LTQ-55

6 g of an aqueous solution of colloidal silica (40%, Ludox AS-40) is mixed with 40 g of an aqueous solution of the organic structure directing agent in its dihydroxide form (R(OH)₂) containing 0.5 equivalents of hydroxide per 1000 g of solution. The mixture is stirred at room temperature until the complete evaporation of the exceeding water content required to reach the final gel composition shown below. In this particular case, 40.1 g of water needs to be evaporated. The gel becomes quite thick and viscous and often it is needed to add the aqueous solution of NH₄F and the seeds before complete evaporation of water and then continue the stirring until the final target weight of the gel.

A solution of 0.74 g of ammonium fluoride in 2 g of water is then added and the mixture is stirred. Finally, a suspension containing 0.12 g of seeds of zeolite ITQ-55 with small crystals (see preparation in Example 3 below) in 1 g of water is also added and the mixture homogenized again. The final gel composition is the following:

SiO₂: 0.25R(OH)₂: 0.5NH₄F:5H₂O

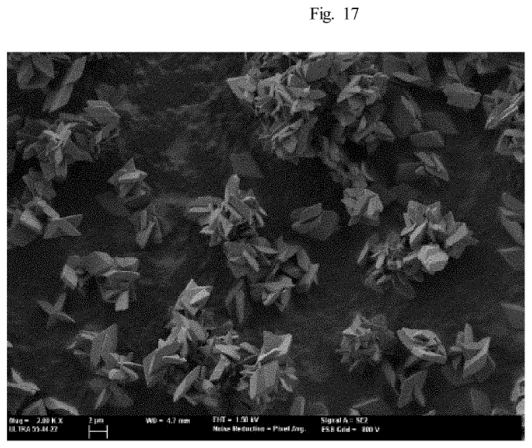

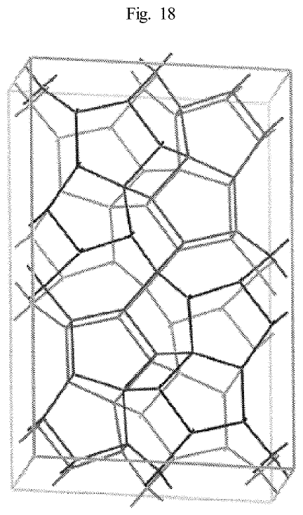

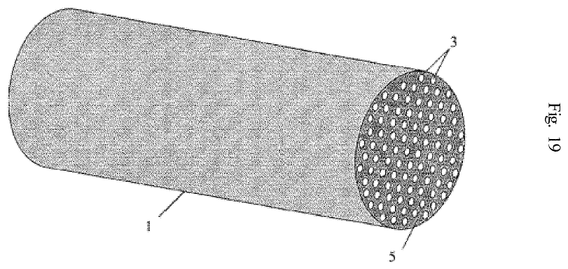

The gel obtained is then loaded in Teflon-lined stainless steel autoclaves and heated in an oven at 125° C. provided with a system that allows rotation (60 rpm) during 8 days. The product obtained after the crystallization is recovered by filtration, washed with distilled water and dried at 100° C. to yield the ITQ-55 sample. Calcination of as-made zeolite ITQ-55 to remove the organic material is carried out at 650° C. for 3 hours in a muffle furnace. The X-ray diffraction (XRD) patterns of the as-prepared and calcined zeolite are shown in FIG. 16. The crystal size and morphology of the crystals can be seen in the field emission scanning electron microscopy (FE-SEM) image in FIG. 17. The zeolite ITQ-55 has a mean crystal particle size within the range of from about 1-2 microns.

### Example 3

### Preparation of Pure Silica Zeolite LTQ-55 Seeds

8 g of tetraethylorthosilicate (TEOS) are mixed with 38.4 g of an aqueous solution of the organic structure directing agent in its dihydroxide form (R(OH)₂) containing 0.5 equivalents of hydroxide per 1000 g of solution. The mixture is stirred at room temperature until the complete evaporation of the ethanol produced upon hydrolysis of TEOS and the exceeding water content required to reach the final gel composition shown below. In this particular case, 7.1 g of ethanol and 29.8 g of water must be evaporated. The final gel composition is the following:

SiO₂:0.25R(OH)₂:10H₂O

The gel obtained is then loaded in Teflon-lined stainless steel autoclaves and heated in an oven at 175° C. provided with a system that allows rotation (60 rpm) during 7 days. The product obtained after the crystallization is recovered by filtration, washed with distilled water and dried at 100° C.

### Example 4

High Kinetic Selectivity of N₂/CH₄ on ITQ-55

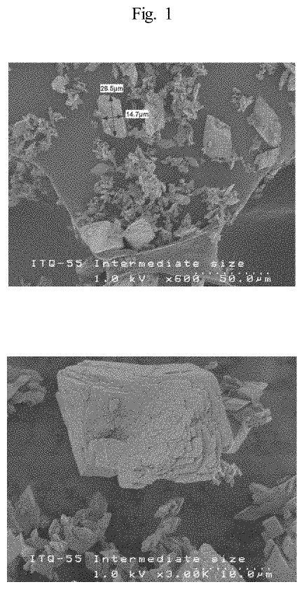

The zeolite ITQ-55 used in this example is made up of zeolite crystal particles having crystals mostly spreading within the range of approximately 2-30 microns with mean value ˜10 microns, as prepared in Example 1. The ITQ-55 is a siliceous zeolite having a tortuous mono-directional small-pore system. The cavities are accessible through two parallel systems of zig-zag 8R channels (ring aperture: 5.9 Å by 2.1 Å). Adsorption and kinetic experiments show molecules larger than 3 Å can be adsorbed, indicating a flexible structure for ITQ-55. Scanning Electron Microscope (SEM) images of ITQ-55 are shown in FIG. 1.

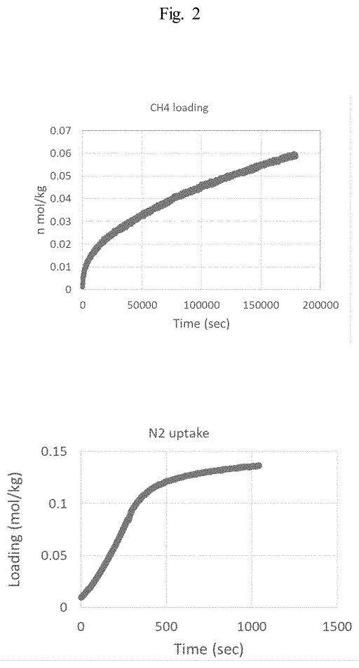

Uptakes of CH₄ and N₂ at 1 bar (˜14.7 psi) and 25° C. were measured on ITQ-55 having a zeolite crystal particle size within the range of approximately 2-30 microns, using a gravimetric instrument. FIG. 2 shows that CH₄ cannot reach equilibrium after 180000 seconds, about 2 days. In contrast, N₂ approaches equilibrium less than 20 minutes, suggesting kinetic ratio at least above 1000.

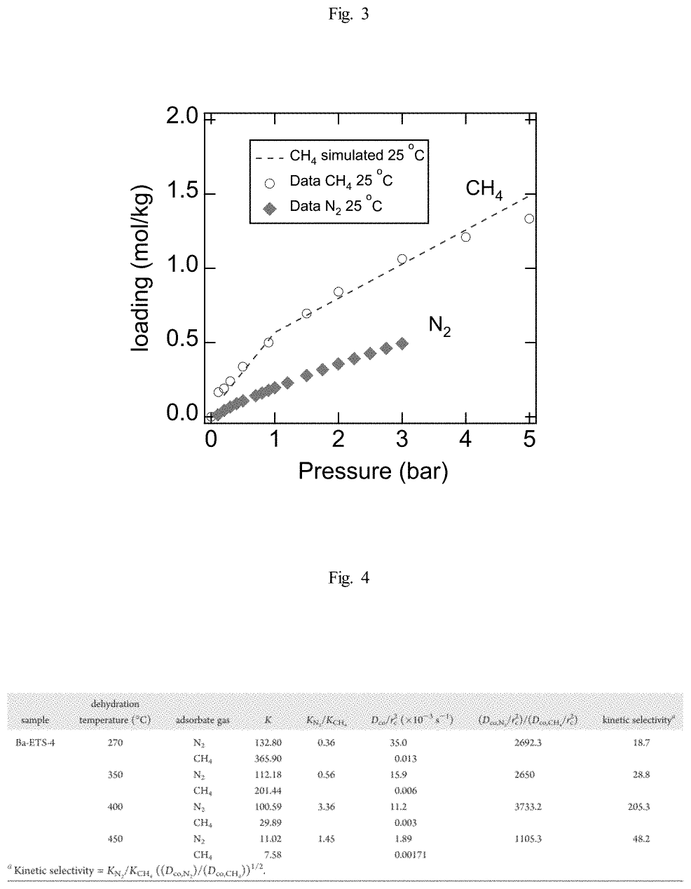

FIG. 3 shows the N₂ and CH₄ isotherms. CH₄ isotherms were measured on a different ITQ-55 sample with nanocrystals, agreeing well with the capacities predicted from the simulation results. N₂ adsorptions measured on the ITQ-55 sample having a mean zeolite crystal particle size within the range of approximately 2-30 microns are compared in FIG. 3. The CH₄ capacity is higher than that of N₂ suggesting equilibrium separation of N₂ is not preferred.

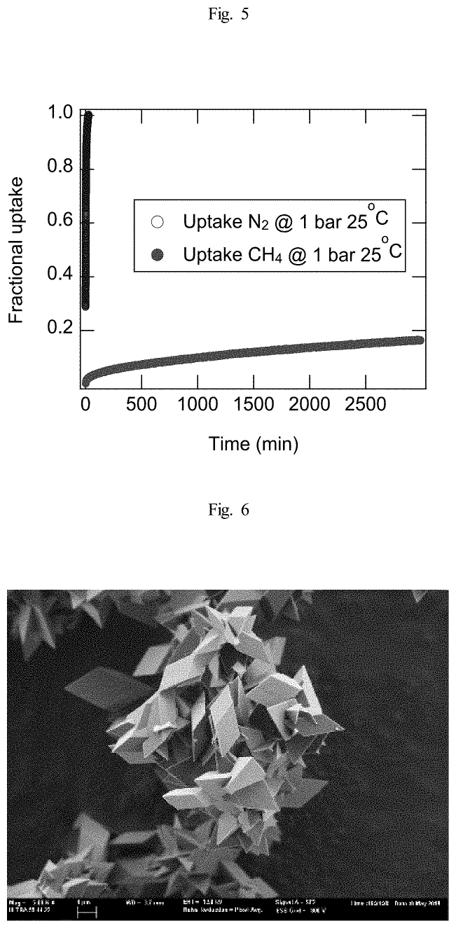

Based on N₂ and CH₄ equilibrium data in FIG. 3, the CH₄ fractional uptake is calculated and compared with N_{2,} shown in FIG. 5. To estimate CH₄ and N₂ diffusion time constants, the short time analysis for mₜ/m_{∞}<0.3, was applied for CH₄ using

$$\frac{{m}_{t}}{{m}_{∞}} \approx \frac{6}{r} \sqrt{\frac{Dt}{π}} \qquad ( 1 )$$

The diffusion time constant (D/r²) for CH₄ is estimated to be in the range of ˜10⁻⁸-10⁻⁹/s. The long time asymptote (mₜ/m_{∞}>0.75) for a spherical adsorbent was applied to N₂ using

$$ln ( 1 - \frac{{m}_{t}}{{m}_{∞}} ) = ln ( \frac{6}{{π}^{2}} ) - \frac{{π}^{2} D}{{r}^{2}} t \qquad ( 2 )$$

Therefore, the diffusion time constants (D/r²) for N₂ is estimated to be about 10⁻⁴/s. The kinetic selectivity

$$\frac{{D}_{{N}_{2}}}{{D}_{{CH}_{4}}}$$

is calculated to be in the range of 10⁴-10⁵. This value is higher than the best kinetic selectivity reported for N₂/CH₄ separation with the Ba-ETS-4 sample, where the kinetic selectivity

$$\frac{{D}_{{N}_{2}}}{{D}_{{CH}_{4}}}$$

reported ˜3733 in Table 1 from reference (Majumdar, B., Bhadra, S J, Marathe, R. P., Farooq, S.: Adsorption and diffusion of methane and nitrogen in barium exchanged

ETS-4. Ind. Eng. Chem. Res. 50(5), 3021-3034 (2011)), shown in FIG. 4.

The overall selectivity based on both equilibrium and diffusivity information is given by

$${s}_{N 2 / CH 4} = \frac{{K}_{N 2}}{{K}_{CH 4}} \sqrt{\frac{{D}_{N 2}}{{D}_{CH 4}}} \qquad ( 3 )$$

Therefore, the overall selectivity (S) is calculated in the range of 100-200 for N₂/CH₄ separation using ITQ-55.

### Example 5

### Tunable Kinetics by Crystal Size to Optimize Cycle Time to Allow Rapid Cycles

Because the dominating mass transfer resistance for CH₄ and N₂ in ITQ-55 found to be the diffusion step, not the surface barrier from frequency response study, the mass transfer rate, e.g., diffusion time constant (D/r²), can be tuned by the crystal size, in proportion to 1/r². In order to use the zeolites in rapid cycle adsorption, the crystal size needs to be reduced to enable fast diffusion time. With combination of an advanced monolith contactor to reduce pressure drop, ITQ-55 can allow a large throughput with a reduced footprint, compared to conventional carbon molecular sieve (CMS) in pellet form, where the dominant resistance existing in surface barrier for kinetic separation of N₂/CH₄ without much room for tunable kinetics. A small crystal size with about 1 um was used to validate the tunable kinetics for CH₄ and N₂ in ITQ-55.

To demonstrate that the kinetics can be tuned with different crystal sizes, a small size crystals ITQ-55 was synthesized and evaluated. FIG. 6 shows the SEM image for the small size ITQ-55 with uniform ˜1 μm size.

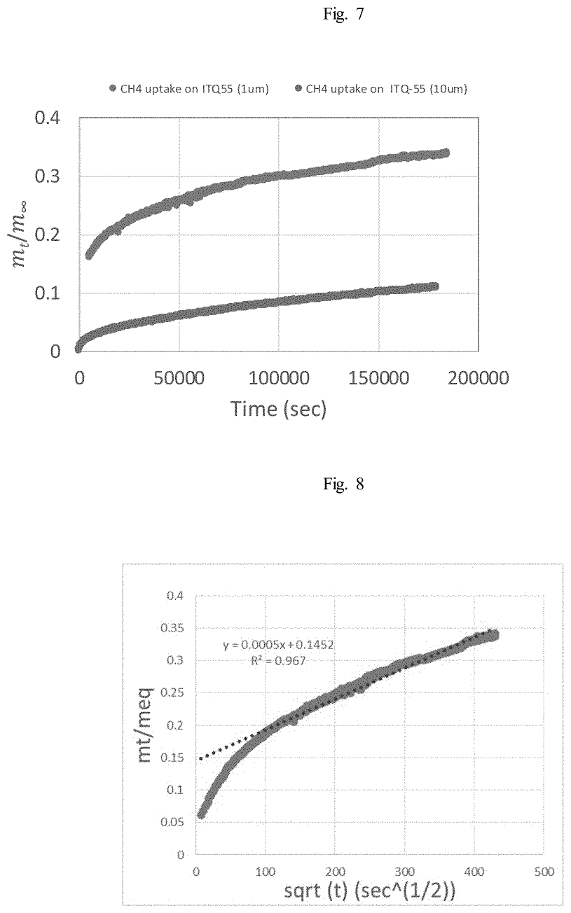

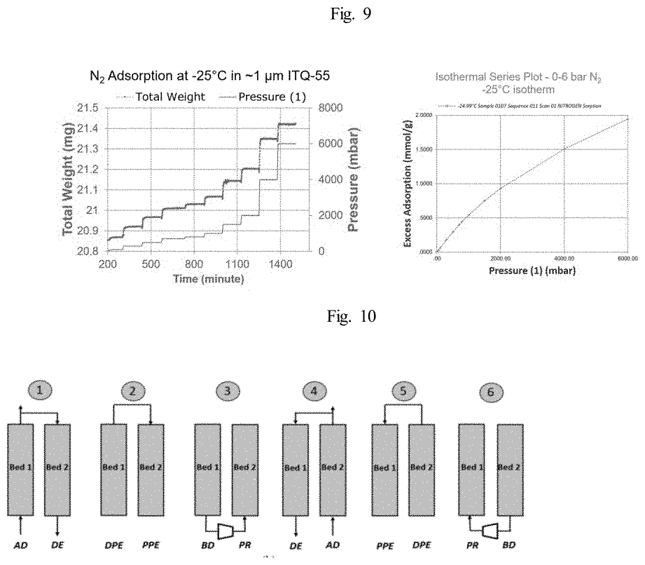

The uptakes of N₂ and CH₄ were measured on these small crystals. FIG. 7 compares the uptakes of CH₄ in both small (SEM in FIG. 6) and medium size crystals (SEM in FIG. 1) at 1 bar (˜14.7 psi) and 25° C. It is clear that CH₄ uptake is faster in small crystals, reaching fractional uptake of 0.3 at 100, 000 sec for small crystals (1 um), while only 0.1 for large crystals (˜10 um). Interestingly, the CH₄ still cannot reach equilibrium over days. The estimation with short time analysis in Equation 1 provides the diffusion time constants (D/r²) for CH₄ in the range of 10⁻⁸/s. FIG. 8 shows an uptake analysis for CH₄ on this small crystal size material. It is evident that N₂ can reach equilibrium in minutes, showing a much short time to reach equilibrium compared to uptakes with the larger crystal size material. N₂ uptake can be too fast to be accurately evaluated from uptake measurement. Even at a lower temperature, the uptake was found to follow the pressure, indicating relatively fast kinetics even at a lower temperature to reach equilibrium shown in FIG. 9. Because the equilibrium capacity at a lower temperature is higher than that at a higher temperature, it is possible to operate the separation at sub ambient temperature to increase capacity for N_{2,} leading to a reduced size separator or higher throughput. For example, the N₂ capacity on this ITQ-55 reaches 2 mol/kg at 6 bar and −25° C.

### Example 6

Evaluation of PSA Cycles to Demonstrate a High Recovery (>90%) for a Wide Range of Feed Conditions for Large Throughput with Monolith Structure

Process simulations were conducted for N₂/CH₄ separations based on previous fundamental equilibrium and kinetic information. The results showed cycles that achieved both high recovery (>90% recovery) and high purity (>98% CH₄)with processes using one with 2 bed 6-step PSA cycle and another with 2 bed 4-step dual-flux cycle

### Example 7

2-Bed 6-Step PSA Process to Separate Methane (Purity >98 mol % and Recovery >90%) from Binary Methane and Nitrogen

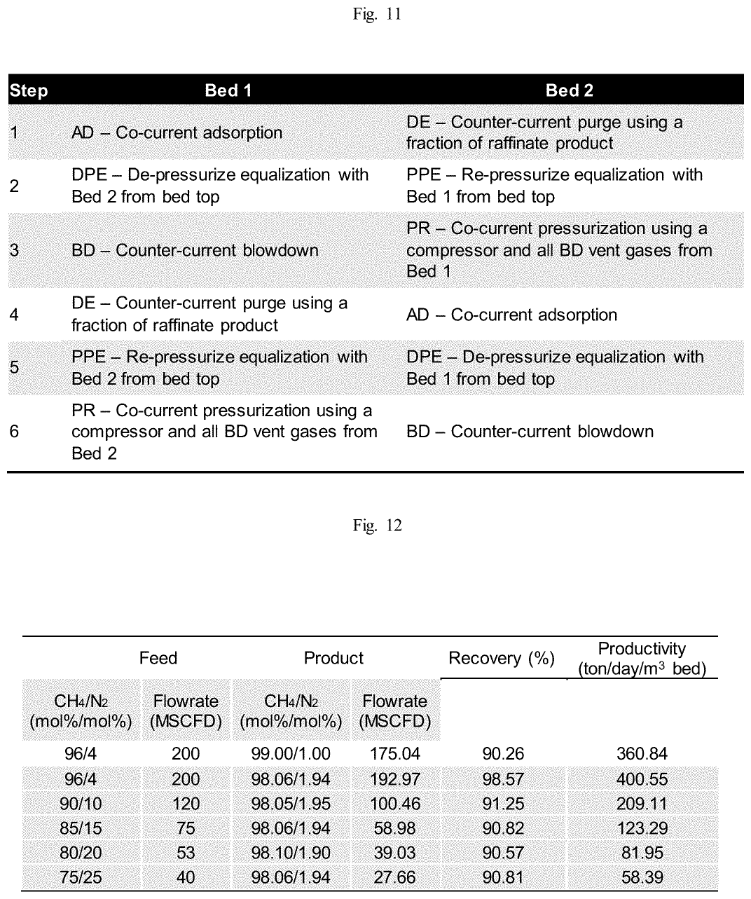

In one simulation, a 2-bed 6-step pressure swing adsorption (PSA) process (schematic diagram shown in FIG. 10a) was used to purify methane from binary methane and nitrogen under various feed concentrations. The PSA system contained monolith bed unit which was coated with kinetically selective zeolitic adsorbent (ITQ-55). The single monolith bed had a dimension of 1.3 meter (diameter)×2.5 meter (length). The PSA cycle consisted of six operating steps, described in FIG. 10b and FIG. 11.

FIG. 12 summarizes the simulation results for cases with different feed conditions, including 96% CH₄+4% N ₂, 90% CH₄+10% N₂, 85% CH₄+15% N₂, 80% CH₄+20% N₂, and 75% CH₄+25% N₂. The desirable methane purity and recovery (>98 mol % purity and >90% recovery) was achieved for a wide feed concentration range of binary methane and nitrogen using 2-bed 6-step PSA process. With a feed composition 96 mol % CH₄/4 mol % N₂, 99.00 mol % methane purity and 90.26% recovery can be achieved. Alternatively, a reduced purity (98.06 mol % methane) but an increased recovery (98.57%) can be obtained. The productivity decreases with the decreasing feed methane concentration. This is because the feed flowrate has to be lowered to avoid too much breakthrough of nitrogen in the product stream. If needed, a cascade scheme of adsorption can be used to achieve high purity of methane product.

In the simulations, moles were calculated based on one cycle of PSA simulation. All feeds were under 1000 psia and 25° C., and cycle time was 30 seconds. Purge pressure for this run was 15.2 psia.

To compare performance of the N₂/CH₄ separation with zeolite ITQ-55 and current commercial adsorbent ETS-4, the same 2-bed 6-step cycle were simulated using ETS-4 and monolith bed for one feed composition of 90% CH₄/10% N₂ at 120 MMSCFD. Adsorption equilibrium and kinetic information are obtained from literature. Barium exchanged ETS-4 is from paper: Adsorption and diffusion of methane and nitrogen in barium exchanged ETS-4, Ind. Chem. Eng. Res., 50, 3021-3034, 2011) and Engelhard ETS-4 from paper on “Nitrogen rejection by dual reflux pressure swing adsorption using Engelhard titanosilicate type 4, Ind. Chem. Eng. Res., 59, 22573-22581, 2020” . For the comparison with the same operating conditions, both ETS-4 show lower CH₄ purity in the product compared to zeolite ITQ-55. The comparison is shown in FIG. 29.

### Example 8

2-Bed 4-Step Dual-Reflux PSA Process to Separate Methane (Purity >98 mol % and Recovery >90%) from Binary Methane and Nitrogen

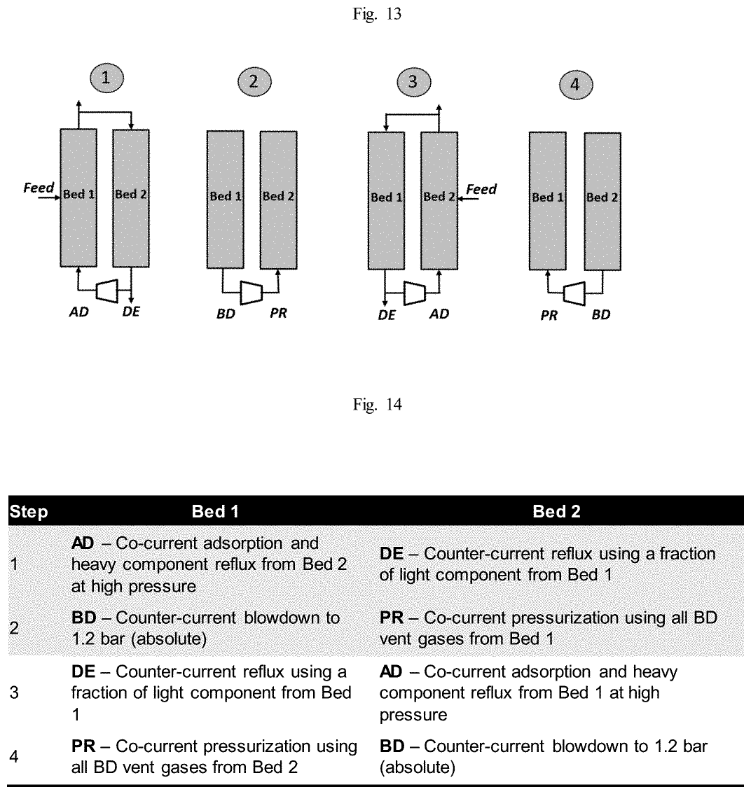

Dual-reflux PSA is an adsorption separation process where heavy and light reflux streams are simultaneously introduced in the beds during adsorption and purge steps. The 2-bed 4-step dual-reflux PSA cycle is presented in FIG. 13 and FIG. 14.

In the simulations, moles were calculated based on one cycle of simulation. The feed stream was under 1000 psia and 25° C. The counter-current purge pressure was 17.4 psia.

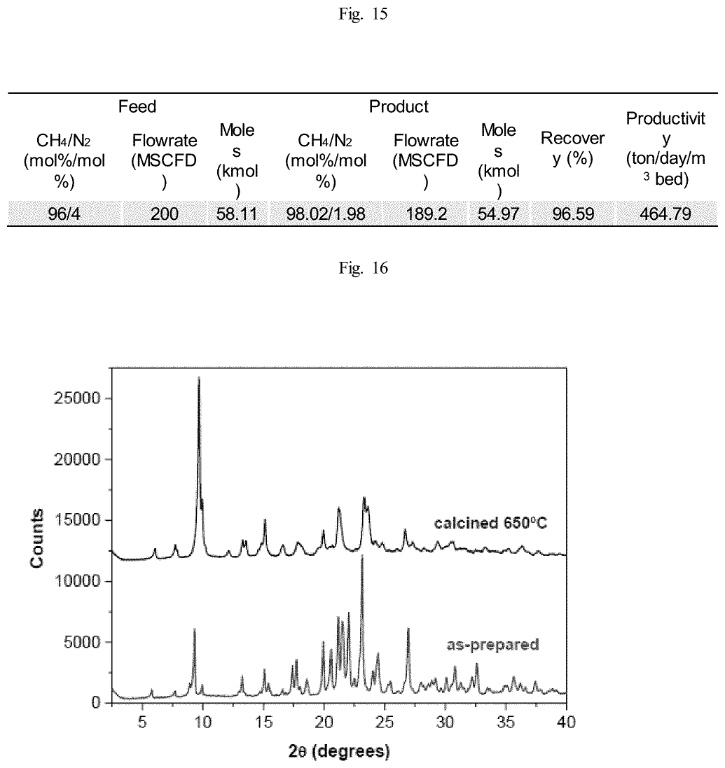

From FIG. 15, with feed composition 96 mol % CH₄/4 mol % N₂, high purity (98.02 mol % methane) and high recovery (96.59%) was achieved from the dual-flux PSA.

Similar to the proposed 2-bed 6-step PSA, the dual-reflux PSA process required a compressor to reflux/recompress the effluent gas from the other bed.

### Example 9

High Pressure N₂/CH₄ Separation by Mixture Breakthrough

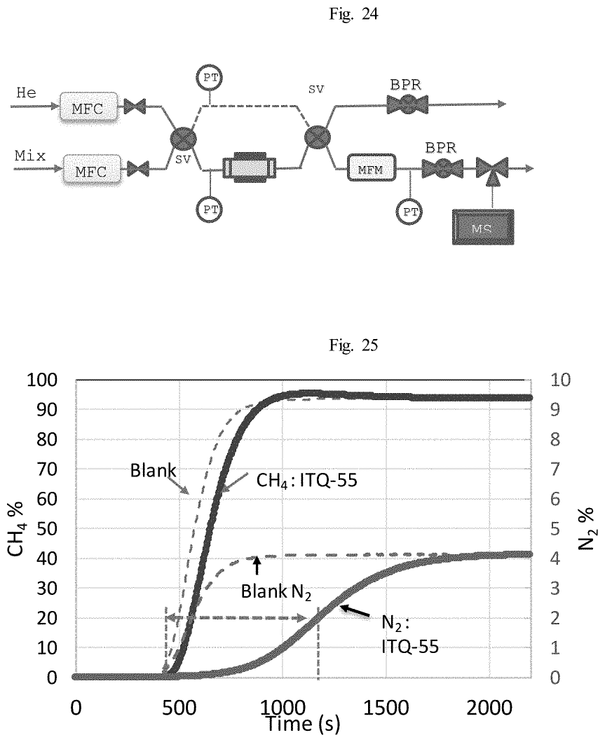

A representative schematic of a breakthrough apparatus is shown in FIG. 24. The adsorption column is packed with the adsorbent ITQ-55 under investigation. The mass flow controllers (MFCs) was set to control the feed flow rate at the desired level. The back-pressure regulator is used to control the column pressure at the desired level. Heat cartridge was clapped outside of adsorption bed to regenerate the sample with helium gas flowing. The breakthrough system is fully automated for operation and data acquisition using LabVIEW programing.

The system dead volume can be determined by running breakthrough by passing the adsorption bed. The green dashed lines between two 4-port switch valves (SV) keep the same length as the green solid lines connecting to switch valves. Additional dead volumes arisen from empty space in the adsorption bed was minimized by filling quartz material before and after adsorbent packing. The system pressure can be tuned using back-pressure regulator on both lines, which could benefit for smooth switching between gases to flow in adsorption bed without much pressure differences. The length to diameter ratio for adsorption bed is about 10.

The system was leak tested by maintaining pressure at 900 psi. Then the blank experiment was run with mixture by-pass adsorption bed at the same operating conditions. Usually the experimental method was setup with helium purging for 5 mins and then switching to feed gas for 1 hour run. Corresponding experiment with adsorption bed was followed by the same method but mixture gas flowing through the packed bed. The breakthrough experiment was completed when the composition profile of the outlet matching the inlet composition. Continuous experiments can be included with purge and adsorption in multiple cycles.

Comparison of the breakthrough of N₂/CH₄ mixture in ITQ-55 bed and blank bed without bed is shown in FIG. 25. The inlet composition is 4% N₂ and 95% CH₄ and 1% He and operating pressure is 900 psi. The experiment starts with a clean bed with pure helium purging at 10 sccm and then switching to mixture at the same flowrate after 120 seconds. For blank experiment, both 4% N₂ and 95% CH₄ breakthrough at the same time ˜400 s. The time delays for breakthrough contributed by the dead volume in the system. For ITQ-55 bed packed with 0.603 g ITQ-55 crystals, CH₄ starts breakthrough about 430 s, showing the similar shape as blank experiment. The 30 s delay can be contributed from dead volume in adsorption bed and/or very little adsorption by ITQ-55. In contrast, N₂ even at 4% dilute concentration shows a very distinguish separation compared to blank experiment, showing adsorption of N₂ in bed to have the outlet stream with less than 2% N₂ from 430 to 1160 s.

### Example 10

### Counter Example of ITQ-55 for Kinetic Separation

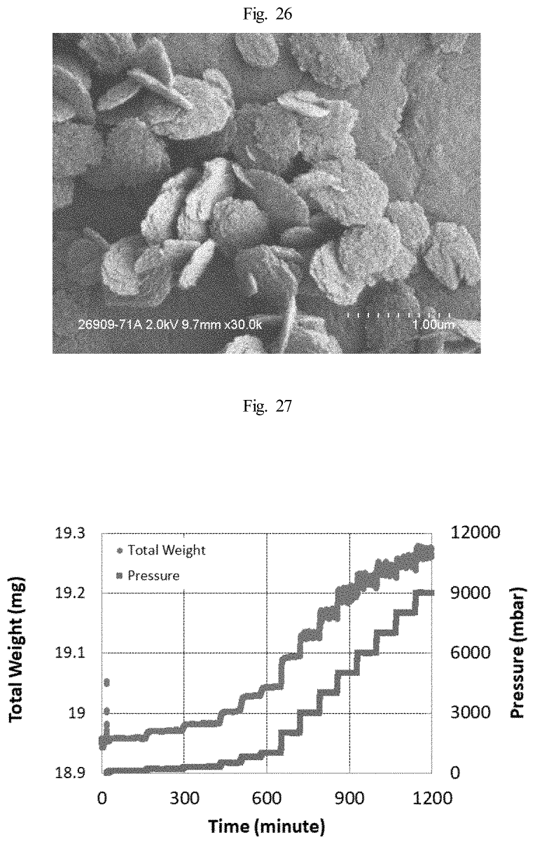

Not all ITQ-55 is feasible for the kinetic separation for upstream gas treating. Even ITQ-55 has high selectivity demonstrate before, the range of crystals suitable for separation, especially for rapid cycle separation is found important for kinetic separation. Here is a counter example of ITQ-55 with nanometer dimension cannot provide desired separation. ITQ-55 was synthesized through OH prep, resulting in a different morphology. FIG. 26 shows the tiny crystals agglomerated to form a thin plate, with a dimension of about 50 nm thickness and 0.5 μm diameter.

The CH₄ uptake on this sample is shown in FIG. 27, with the weight change almost following the pressure change, indicating fast kinetics of CH₄ to reach equilibrium in short time. This clearly indicates faster kinetics on this sample, in contrast to previous samples with intermediate size and small crystals having over hours or days for each pressure.

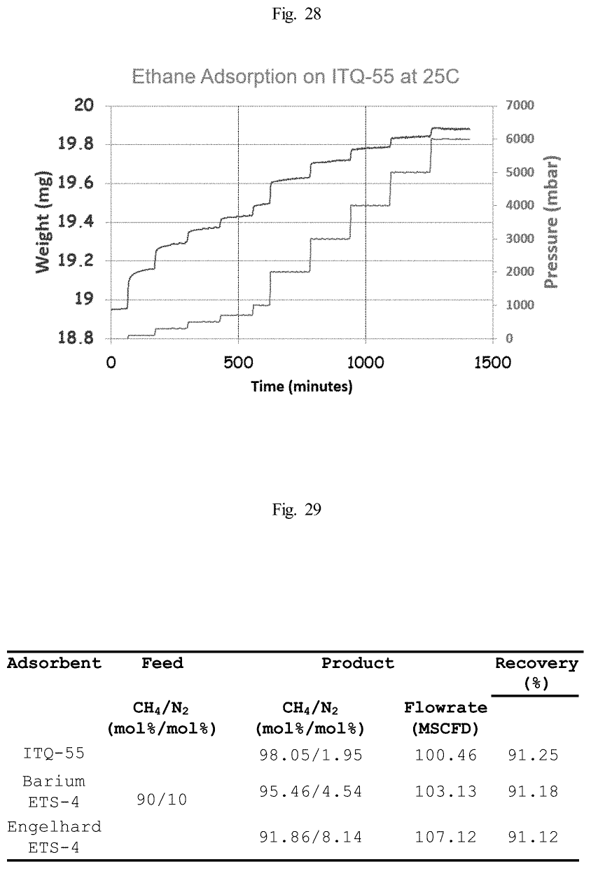

Due to fast kinetics in the very thin plate crystals, the isotherms of CH4 can even be measured at subzero temperatures, suggesting CH₄ is not kinetic limited in ITQ-55 crystals with less than 50 nm transport length. A further evaluation of other hydrocarbons with larger size such as ethane and ethylene, also shows reasonable uptake in short time, shown in FIG. 28.

Therefore, this type of ITQ-55 crystals are not suitable for upstream gas treating, to kinetically separate CH₄ and other HCs from light gases N₂ with smaller molecular size. The cycle time could be too slow to effectively limit CH₄ co-adsorption, result an unsuccessful kinetic separation that depends on both kinetics selectivity and mass transfer rates.

As for the other end, the separation is not efficient when the crystal size is too big, which has very slow kinetic rate for crystals over 60 This results the separation of long residence time and very big size bed.

### PCT and EP Clauses:

1. A process for adsorbing nitrogen from a feed stream containing hydrocarbons and impurities, wherein the hydrocarbons comprise at least methane and the impurities comprise at least nitrogen, said process comprising passing the feed stream at feed pressure through a bed of an adsorbent comprising zeolite ITQ-55 to adsorb nitrogen from the feed stream, thereby producing a product stream at feed pressure that is depleted in nitrogen; wherein the zeolite ITQ-55 has a mean crystal particle size within the range of from about 0.01 microns to about 40 microns; and wherein the feed stream is exposed to the zeolite ITQ-55 at effective conditions for performing a kinetic separation, in which the kinetic separation exhibits greater kinetic selectivity for nitrogen than for methane.

2. The process of clause 1 wherein the feed pressure is from about 13.8 bar (˜200 psi) to about 110 bar (˜1600 psi), or from about 34.5 bar (˜500 psi) to about 103 bar (˜1500 psi), or from about 41.4 bar (˜600 psi) to about 96.5 bar (˜1400 psi).

3. The process of clauses 1 and 2, which is a swing adsorption process comprising an adsorption step performed at elevated pressure and/or reduced temperature in which the feed stream is passed through a bed of adsorbent comprising the zeolite ITQ-55 to adsorb nitrogen from the feed stream, and a desorption step performed at reduced pressure and/or elevated temperature in which nitrogen from the previous adsorption step is desorbed from the bed to regenerate the bed for the next adsorption step.

4. The process of clauses 1-3, which is a rapid swing adsorption process, wherein the rapid swing adsorption process is selected from rapid cycle thermal swing adsorption (RCTSA), rapid cycle pressure swing adsorption (RCPSA), and rapid cycle partial pressure swing adsorption

(RCPPSA). wherein the bed of adsorbent is configured as a monolith having a plurality of parallel channels.

5. The process of clauses 1-4, wherein the kinetic separation exhibits greater kinetic selectivity for nitrogen than for methane, at a temperature from about −40° C. to about 50° C., and at a pressure of about 1 bar (˜14.7 psi) to about 100 bar (˜1450 psi).

6. The process of clauses 1-5, which is a swing adsorption process comprising a feed step, one or more down equalization steps, a co-current or counter-current blow down and depressurization, one or more up equalization steps, and feed re-pressurization.

7. The process of clauses 1-6, wherein the zeolite ITQ-55 has a mean crystal particle size from about 0.01 microns to about 15 microns, or from about 0.01 microns to about 2 microns, or from about 0.05 microns to about 2 microns.

8. The process of clauses 1-7, wherein the kinetic separation exhibits faster kinetic activity for nitrogen than for methane, at a temperature from about −10° C. to about 30° C., and at a pressure of about 2 bar (˜29 psi) to about 100 bar (˜1450 psi).

9. The process of clauses 1-8, wherein the feed stream comprises natural gas, a hydrocarbon stream containing nitrogen and optionally carbon dioxide, or a hydrocarbon stream containing nitrogen, water and optionally carbon dioxide.

10. The process of clauses 1-9, wherein hydrocarbon recovery in the product stream is greater than about 80%, or greater than about 90%, and hydrocarbon purity in the product stream is greater than about 90%, or greater than about 95%.

11. A process of adsorbing nitrogen and carbon dioxide from a feed stream containing hydrocarbons and impurities, wherein the hydrocarbons comprise at least methane and the impurities comprise at least nitrogen and carbon dioxide, said process comprising passing the feed stream through one or more beds of adsorbent comprising zeolite ITQ-55; wherein the zeolite ITQ-55 has a mean crystal particle size within the range of from about 0.1 microns to about 40 microns; wherein the feed stream is exposed to the adsorbent at effective conditions for performing a kinetic separation, in which the kinetic separation exhibits greater kinetic selectivity for nitrogen and carbon dioxide than for methane.

12. A method for separating fluids, comprising:

exposing an input fluid stream comprising a first fluid component and a second fluid component to an adsorbent comprising zeolite ITQ-55 to form a rejection product fluid stream, a molar ratio of the first fluid component to the second fluid component in the rejection product fluid stream being less than a molar ratio of the first fluid component to the second fluid component in the input fluid stream;

collecting the rejection product fluid stream;

forming an adsorbed product fluid stream, a molar ratio of the first fluid component to the second fluid component in the adsorbed product stream being greater than the molar ratio of the first fluid component to the second fluid component in the input fluid stream; and

collecting the adsorbed product stream,

wherein the zeolite ITQ-55 has a mean crystal particle size within the range of from about 0.01 microns to about 40 microns; wherein the input fluid stream is exposed to the zeolite ITQ-55 at effective conditions for performing a kinetic separation, in which the kinetic separation exhibits greater kinetic selectivity for the first fluid component than for the second fluid component.

13. The method of clause 12, wherein the first fluid component is nitrogen and optionally carbon dioxide, and the second fluid component is methane.

14. The method of clauses 12 and 13 further comprising producing the rejection product fluid stream at feed pressure.

15. The method of clauses 12-14, wherein the feed pressure is from about 13.8 bar (˜200 psi) to about 110 bar (˜1600 psi), or from about 34.5 bar (˜500 psi) to about 103 bar (˜1500 psi), or from about 41.4 bar (˜600 psi) to about 96.5 bar (˜1400 psi).

All patents and patent applications, test procedures (such as ASTM methods, UL methods, and the like), and other documents cited herein are fully incorporated by reference to the extent such disclosure is not inconsistent with this disclosure and for all jurisdictions in which such incorporation is permitted.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. A process for adsorbing nitrogen from a feed stream containing hydrocarbons and impurities, wherein the hydrocarbons comprise at least methane and the impurities comprise at least nitrogen, said process comprising passing the feed stream at feed pressure through a bed of an adsorbent comprising zeolite ITQ-55 to adsorb nitrogen from the feed stream, thereby producing a product stream at feed pressure that is depleted in nitrogen; wherein the zeolite ITQ-55 has a mean crystal particle size within the range of from about 0.01 microns to about 40 microns; and
wherein the feed stream is exposed to the zeolite ITQ-55 at effective conditions for performing a kinetic separation, in which the kinetic separation exhibits greater kinetic selectivity for nitrogen than for methane.

2. The process of claim 1 wherein the feed pressure is from about 13.8 bar (˜200 psi) to about 110 bar (˜1600 psi), or from about 34.5 bar (˜500 psi) to about 103 bar (˜1500 psi), or from about 41.4 bar (˜600 psi) to about 96.5 bar (˜1400 psi).

3. The process of claim 1, which is a swing adsorption process comprising an adsorption step performed at elevated pressure and/or reduced temperature in which the feed stream is passed through a bed of adsorbent comprising the zeolite ITQ-55 to adsorb nitrogen from the feed stream, and a desorption step performed at reduced pressure and/or elevated temperature in which nitrogen from the previous adsorption step is desorbed from the bed to regenerate the bed for the next adsorption step.

4. The process of claim 3, which is a rapid swing adsorption process, wherein the rapid swing adsorption process is selected from rapid cycle thermal swing adsorption (RCTSA), rapid cycle pressure swing adsorption (RCPSA), and rapid cycle partial pressure swing adsorption (RCPPSA). wherein the bed of adsorbent is configured as a monolith having a plurality of parallel channels.

5. The process of claim 1, wherein the kinetic separation exhibits greater kinetic selectivity for nitrogen than for methane, at a temperature from about −40° C. to about 50° C., and at a pressure of about 1 bar (˜14.7 psi) to about 100 bar (˜1450 psi).

6. The process of claim 1, which is a swing adsorption process comprising a feed step, one or more down equalization steps, a co-current or counter-current blow down and depressurization, one or more up equalization steps, and feed re-pressurization.

7. The process of claim 1, wherein the zeolite ITQ-55 has a mean crystal particle size from about 0.01 microns to about 15 microns, or from about 0.01 microns to about 2 microns, or from about 0.05 microns to about 2 microns.

8. The process of claim 1, wherein the kinetic separation exhibits faster kinetic activity for nitrogen than for methane, at a temperature from about −10° C. to about 30° C., and at a pressure of about 2 bar (˜29 psi) to about 100 bar (˜1450 psi).

9. The process of claim 1, wherein the feed stream comprises natural gas, a hydrocarbon stream containing nitrogen and optionally carbon dioxide, or a hydrocarbon stream containing nitrogen, water and optionally carbon dioxide.

10. The process of claim 1, wherein hydrocarbon recovery in the product stream is greater than about 80%, or greater than about 90%, and hydrocarbon purity in the product stream is greater than about 90%, or greater than about 95%.

11. A process of adsorbing nitrogen and carbon dioxide from a feed stream containing hydrocarbons and impurities, wherein the hydrocarbons comprise at least methane and the impurities comprise at least nitrogen and carbon dioxide, said process comprising passing the feed stream through one or more beds of adsorbent comprising zeolite ITQ-55; wherein the zeolite ITQ-55 has a mean crystal particle size within the range of from about 0.1 microns to about 40 microns; wherein the feed stream is exposed to the adsorbent at effective conditions for performing a kinetic separation, in which the kinetic separation exhibits greater kinetic selectivity for nitrogen and carbon dioxide than for methane.

12. A method for separating fluids, comprising:
exposing an input fluid stream comprising a first fluid component and a second fluid component to an adsorbent comprising zeolite ITQ-55 to form a rejection product fluid stream, a molar ratio of the first fluid component to the second fluid component in the rejection product fluid stream being less than a molar ratio of the first fluid component to the second fluid component in the input fluid stream;
collecting the rejection product fluid stream;
forming an adsorbed product fluid stream, a molar ratio of the first fluid component to the second fluid component in the adsorbed product stream being greater than the molar ratio of the first fluid component to the second fluid component in the input fluid stream; and
collecting the adsorbed product stream,
wherein the zeolite ITQ-55 has a mean crystal particle size within the range of from about 0.01 microns to about 40 microns; wherein the input fluid stream is exposed to the zeolite ITQ-55 at effective conditions for performing a kinetic separation, in which the kinetic separation exhibits greater kinetic selectivity for the first fluid component than for the second fluid component.

13. The method of claim 12, wherein the first fluid component is nitrogen and optionally carbon dioxide, and the second fluid component is methane.

14. The method of claim 12 further comprising producing the rejection product fluid stream at feed pressure.

15. The method of claim 14 wherein the feed pressure is from about 13.8 bar (˜200 psi) to about 110 bar (˜1600 psi), or from about 34.5 bar (˜500 psi) to about 103 bar (˜1500 psi), or from about 41.4 bar (˜600 psi) to about 96.5 bar (˜1400 psi).

16. The method of claim 12, which is a swing adsorption process comprising an adsorption step performed at elevated pressure and/or reduced temperature in which the feed stream is passed through a bed of adsorbent comprising the zeolite ITQ-55 to adsorb nitrogen from the input fluid stream, and a desorption step performed at reduced pressure and/or elevated temperature in which nitrogen from the previous adsorption step is desorbed from the bed to regenerate the bed for the next adsorption step.

17. The method of claim 16, which is a rapid swing adsorption process, wherein the rapid swing adsorption process is selected from rapid cycle thermal swing adsorption (RCTSA), rapid cycle pressure swing adsorption (RCPSA), and rapid cycle partial pressure swing adsorption (RCPPSA).

18. The method of claim 12, wherein the kinetic separation exhibits greater kinetic selectivity for nitrogen than for methane, at a temperature from about −40° C. to about 50° C., and at a pressure of about 1 bar (˜14.7 psi) to about 100 bar (˜1450 psi).

19. The method of claim 12, wherein the zeolite ITQ-55 has a mean crystal particle size within the range of from about 0.01 microns to about 15 microns, or from about 0.01 microns to about 2 microns, or from about 0.1 microns to about 2 microns.

20. The method of claim 12, wherein the kinetic separation exhibits faster kinetic activity for nitrogen than for methane, at a temperature from about −10° C. to about 30° C., and at a pressure of about 2 bar (˜29 psi) to about 100 bar (˜1450 psi).

21. The method of claim 12, wherein the first fluid component is N_{2,} a combination of N₂ and CO₂, or a combination of N₂ and another fluid component, and wherein the second fluid component is CH₄, a hydrocarbon having a higher molecular weight than CH₄, or a combination thereof.

22. The method of claim 12, wherein the input fluid stream comprises natural gas, a hydrocarbon stream containing nitrogen and optionally carbon dioxide, or a hydrocarbon stream containing nitrogen, water and optionally carbon dioxide.

23. The method of claim 12, wherein methane recovery in the rejection product fluid stream is greater than about 80%, or greater than about 90%, and methane purity in the rejection product fluid stream is greater than about 90%, or greater than about 95%.
